(19) United States
(12) Patent Application Publication
(10) Pub. No.: US 2012/0140069 A1
(43) Pub. Date: Jun. 7, 2012

(54) SYSTEMS AND METHODS FOR GATHERING VIEWERSHIP STATISTICS AND PROVIDING VIEWER-DRIVEN MASS MEDIA CONTENT

(75) Inventors: Feng Ding, Singapore (SG); Ramachandiran Durai Vaithilingam, Singapore (SG); Thirugnanam Kaneshalingam, Singapore (SG); Ding Yanjun, Singapore (SG); Mark Joseph Gravina, Singapore (SG); Thajudeen Shahul Hameed, Singapore (SG); Danny Lee Mabey, Farmington, UT (US)

(73) Assignee: 121VIEW USA, Holladay, UT (US)

(21) Appl. No.: 13/308,081

(22) Filed: Nov. 30, 2011

Related U.S. Application Data
(60) Provisional application No. 61/418,291, filed on Nov. 30, 2010.
(60) Provisional application No. 61/418,295, filed on Nov. 30, 2010.

(51) Int. Cl. H04N 7/18

(52) U.S. Cl. 348/143; 348/E07.085

(57) ABSTRACT

Systems and methods of gathering viewership statistics on viewers of mass media content and providing content based on identified characteristics of viewers. One embodiment includes a content distribution space, a content item, and an audience measurement system having a camera, and a processing unit. The audience measurement system can identify characteristics of viewers of an audience and gather statistics, including, but not limited to, how many views of the content item, how long each view is, and the number of opportunities to see (OTSs). The identified characteristics of the viewers of the audience can be used to identify a content item to present on the content distribution space.

### RELATED APPLICATIONS

This application claims the benefit under 35 U.S.C. §119(e) of U.S. Provisional Patent Application No. 61/418,291, filed Nov. 30, 2010, and titled “SYSTEMS AND METHODS FOR PROVIDING VIEWER-DRIVEN MASS MEDIA CONTENT,” and U.S. Provisional Patent Application No. 61/418,295, filed Nov. 30, 2010, and titled “SYSTEMS AND METHODS TO GATHER CONTENT VIEWERSHIP STATISTICS,” both of which are hereby incorporated by reference herein in their entirety.

### TECHNICAL FIELD

The present disclosure relates to systems and methods of gathering statistics on the viewers of out-of-home mass media content and providing viewer-driven content, and more specifically to systems and methods of providing “out-of-home” (OOH) mass media content based on gathered statistics and the characteristics of a detected viewer.

### BRIEF DESCRIPTION OF THE DRAWINGS

Additional aspects and advantages will be apparent from the following detailed description of preferred embodiments, which proceeds with reference to the accompanying drawings, of which:

FIG. 1 is a content viewership system, according to one embodiment.

FIG. 1A is a processing unit of a content viewership system, according to one embodiment.

FIG. 2 is another content viewership system that displays a plurality of content items according to viewer groups, according to one embodiment.

FIG. 2A is a processing unit of the content viewership system of FIG. 2, according to one embodiment.

FIG. 3 is a high-level flow diagram of a method for gathering content viewership statistics, according to one embodiment.

FIG. 4 is flow diagram of a method for detecting a viewer, according to one embodiment.

FIG. 5 is a flow diagram of a method for classifying a viewer, according to one embodiment.

FIG. 6 is a flow diagram of a method for identifying targeted content for a particular detected viewer, according to one embodiment.

FIG. 7 is a high-level flow diagram of a method for gathering content viewership statistics, according to another embodiment.

FIG. 8 is a system for providing viewer-driven content, according to one embodiment.

FIG. 8A is a processing unit of a system for providing viewer-driven content, according to one embodiment.

FIG. 8B is a system for providing viewer-driven content, according to another embodiment.

FIG. 9 is a high-level flow diagram of a method for providing viewer-driven content, according to one embodiment.

FIG. 10 is a content viewership system, according to one embodiment.

FIG. 10A is a client processing unit of a content viewership system, according to one embodiment.

FIG. 10B is a server processing unit of a content viewership system, according to one embodiment.

FIG. 11 is a viewer-driven content delivery system that displays a plurality of content items according to viewer groups, according to one embodiment.

FIG. 11A is a client processing unit of the system for delivering viewer-driven content of FIG. 11, according to one embodiment.

FIG. 11B is a server processing unit of the system for delivering viewer-driven content of FIG. 11, according to one embodiment.

### DETAILED DESCRIPTION OF PREFERRED EMBODIMENTS

Society has experienced a substantial growth of mass media during the past century, driven by advances in technology, including technology that allows easy duplication of material. Physical duplication technologies such as printing, record pressing and film duplication have enabled the duplication of books, newspapers and movies at low prices to huge audiences. The ease with which digital content is copied and distributed over computer networks, such as the Internet, has further hastened the proliferation of mass media content. Consequently, each day society is inundated with increasing amounts of content.

The constant deluge of content has lead to increasing efforts by consumers to tune out or otherwise filter unwanted content. In effect, the ever increasing flood of content has resulted in decreased effectiveness of mass media in reaching an intended audience. Consumers simply have learned to be more selective about the content they choose to consume, filtering content that is of little interest or concern.

Both the increased amounts of content and consumer selectivity with regards to content are challenging for mass media producers that are particularly interested in reaching a target audience. The increased availability of content has resulted in a simultaneous increased demand for advertising space, or “air time,” driving the prices of these increasingly higher. Meanwhile, consumer selectivity with regards to content is particularly challenging for content producers aiming to reach a target audience. For example, advertisers seek to persuade potential customers to buy a product or service. Consumer selectivity has reduced the effectiveness of advertising space in reaching an intended audience and persuading that audience to purchase. As a result, advertisers have sought ways to focus distribution of advertisements. “Targeted advertising” and “targeted distribution channels” are familiar buzz words to refer to the advertising industry's attempts to be increasingly efficient in reaching an intended audience.

Certain mass media distribution channels are well-suited to facilitate targeted advertising or distribution. The Internet provides natural and logical incorporation of powerful computer technology to gather statistics and analytics and to use the gathered information to provide targeted content.

Other mass media channels seem to defy targeted distribution. “Out-of-home” (OOH) advertising, or simply outdoor advertising, is one such distribution channel through which providing targeted advertising is challenging. OOH advertising is essentially any type of advertising that reaches the consumer while he or she is outside the home, in contrast with broadcast, print, and internet advertising. OOH advertising, therefore, is focused on marketing to consumers when they are in public places. The consumers, for example, may be in transit, may be waiting in a public place (such as in a medical office or a subway station), or may be shopping or otherwise transacting business in commercial locations (such as in a retail venue). Familiar OOH advertising formats include billboards, street furniture, and transit advertising (on and/or in busses, taxis, trains, trucks, etc.). Like most advertising space, OOH advertising space is sold based on the number of intended viewers that can potentially be reached. More so than other advertising space, quantifying and identifying the number and type of viewers to be reached can be quite challenging.

Because the consumers receiving OOH advertising are on the go, and not readily identifiable or necessarily associated with a location, a group, a preference, or other characteristic, gathering statistical and analytical information about the viewers of OOH advertising can be extremely challenging. Ascertaining the number of viewers of an advertisement is often guess work or estimation, at best. Ascertaining the characteristics of viewers of OOH advertising, including gender, age, ethnicity, interests, social class, and other demographic information, has proven even more elusive. Currently, gathering viewership statistics involves a human observation and recordation of the observations. Companies such as Arbitron Inc. and The Nielsen Company hire people to monitor content consumers and manually record statistics. The challenges in ascertaining viewer characteristics have impeded providing viewer-driven OOH content generally, and OOH advertisements specifically.

The present disclosure is directed to systems and methods of gathering viewership statistics on the viewers of OOH mass media content. One embodiment of a content viewership system according to the present disclosure may include content distribution space, a content item, and an audience measurement system having a camera, and a processing unit. The audience measurement system can gather statistics, including, but not limited to, how many views of the content item, how long each view is, and the number of opportunities to see (OTSs). The statistics are gathered automatically using computer vision algorithms. These computer algorithms can include face detection, upper-body detection, motion tracking, age classification, gender classification, and ethnicity classification.

Another embodiment of the present disclosure is a method for gathering viewership statistics on the viewers of out-of-home mass media content. A content item is presented to potential viewers. An audience measurement system can detect viewers of the one or more content items and measure audience related metrics, including, but not limited to, view count, view duration, OTS, gender split, age split. The data can be collected and stored in a statistics log based on time.

Another embodiment of the present disclosure includes a content viewership system in a distributed environment comprising content distribution space, a content item, a camera, a client processing unit, and a server processing unit. The content viewership system captures images of an approaching potential viewer and can process the one or more images using computer vision (CV) algorithms to ascertain various characteristics and information about a viewer. For example, the client processing unit may perform face detection, upper-body detection, and motion tracking. Furthermore, the client processing system may identify characteristics of a viewer and classify the viewer according to characteristics such as age, gender, and ethnicity. The client processing unit may perform the (CV) image processing algorithms locally, close to the camera. The server processing unit may receive image data from the client processing unit and/or processed image data and perform Digital Signage (DS) processing algorithms remotely and centrally. The server processing unit may also gather viewership statistics, including but not limited to, how many views of a piece of content, duration of each view, and the number of opportunities-to-see (OTSs). The client processing unit may also gather the same or similar viewership statistics.

Another embodiment of the present disclosure is a method for gathering viewership statistics of dynamically presented mass media content. A content delivery system on a first machine may facilitate presenting one or more content items to potential viewers, typically on one or more display screens. A content display log is stored by the content delivery system, recording when each content item is presented based on time. An audience measurement system can operate on the same machine, or on a machine associated with the screen. The audience measurement system can detect viewers of the one or more content items and measure audience related metrics, including, but not limited to, view count, view duration, OTS, gender split, age split. The data can be collected and stored in a statistics log based on time. A log integrator can auto generate integrated statistics from the content display log and the audience measurement log, based on time. Additional content can be presented based on viewer classification and/or the gathered statistics.

The present disclosure is also directed to systems and methods for providing viewer-driven OOH mass media content. One embodiment of a system for providing viewer-driven OOH mass media content, according to the present disclosure, may include a content delivery system and an audience measurement system. The content delivery system may include a content distribution space, a media player coupled to the content distribution space, and a plurality of content items. The audience measurement system can include a camera and a processing unit. The audience measurement system can gather characteristics and information about an approaching viewer, including but not limited to gender, age, and ethnicity. The audience measurement system can automatically gather the characteristics and information about a viewer using computer vision algorithms. The camera may capture one or more images of an approaching potential viewer and the processing unit can process the one or more images using computer vision algorithms to ascertain various characteristics and information about a viewer. For example, the audience measurement system may perform face detection, upper-body detection, and motion tracking. Furthermore, the audience measurement system may identify characteristics of a viewer and classify the viewer according to characteristics, such as for example, age, gender, and ethnicity. The identified characteristics can be used to identify one or more of a plurality of content items to present on the content distribution space. In this manner the content presented on the content distribution space is driven by the potential viewers of the content. The audience measurement system may also gather viewership statistics, including but not limited to, how many views of a piece of content, duration of each view, and the number of opportunities-to-see (OTSs).

Another embodiment of the present disclosure is a method for providing viewer-driven OOH mass media content. The method may include associating a plurality of content items with one or more audience classifications, detecting an audience of one or more viewers, detecting characteristics of each viewer in the audience, such as for example, gender, age and/or ethnicity, characterizing the audience based on the characteristics of each viewer in the audience, identifying one of a plurality of content items associated with one or more of the audience classifications, and presenting the one of the plurality of content items on a content distribution space. The method may further include applying one or more rules, which may provide additional information indicating how the system should behave for a given audience.

Another embodiment of a system for delivering viewer-driven OOH mass media content in a distributed environment may include a content distribution space, a media player coupled to the content distribution space, a plurality of content items, a camera, a client processing unit, and a server processing unit. The client processing unit may receive image data from the camera and process the image data and/or communicate the image data to the server processing unit for processing. The client processing unit may perform computer vision (CV) image processing algorithms locally, close to the camera, to automatically gather viewer characteristics and communicate the viewership statistics to the server processing unit. For example, the client processing unit may perform face detection, upper-body detection, motion detection, and object tracking. Furthermore, the client processing system may identify characteristics of a viewer and classify the viewer according to characteristics such as age, gender, and ethnicity. The server processing unit may receive image data from the client processing unit and/or processed image data and perform Digital Signage (DS) processing algorithms remotely and centrally. The characteristics can be used to identify one or more of a plurality of content items to present on the content display. In this manner, the content presented on the content display is driven by the potential viewers of the content. The server processing unit may also gather viewership statistics, including but not limited to, how many views of a piece of content, duration of each view, and the number of opportunities-to-see (OTSs).

Another embodiment of the present disclosure is a method for providing viewer-driven OOH mass media content. The method may include associating a plurality of content items with one or more viewer classifications, detecting a viewer by capturing image data with a camera and processing that image data on a client processing unit using computer vision algorithms. The client processing unit may classify the viewer according to gender, classify the viewer according to age, and classify the viewer according to ethnicity to ascertain characteristics about the viewer. The viewer characteristics may be communicated through a network to a remote server processing unit, which can identify one of a plurality of content items that is targeted to the viewer based on gender, age and ethnicity. An indication of the content item, or the content item itself, can then be communicated to the client processing unit and presented on a content display.

While the present disclosure is described in the context of OOH advertising, it should be understood that the disclosure is not so limited. The embodiments of the disclosure can be implemented and applied to other forms of content distribution and other types of mass media content, including, for example, “in-home” forms of mass media distribution such as the Internet and broadcast television. The embodiments disclosed herein are applicable in any mass media content distribution situation where mass media content can be presented.

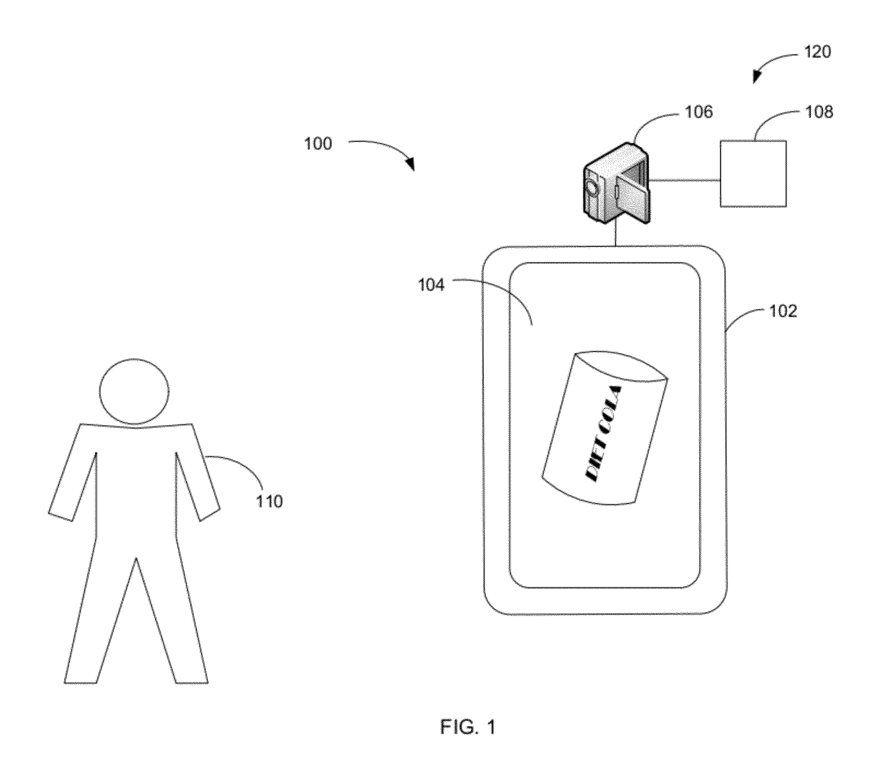

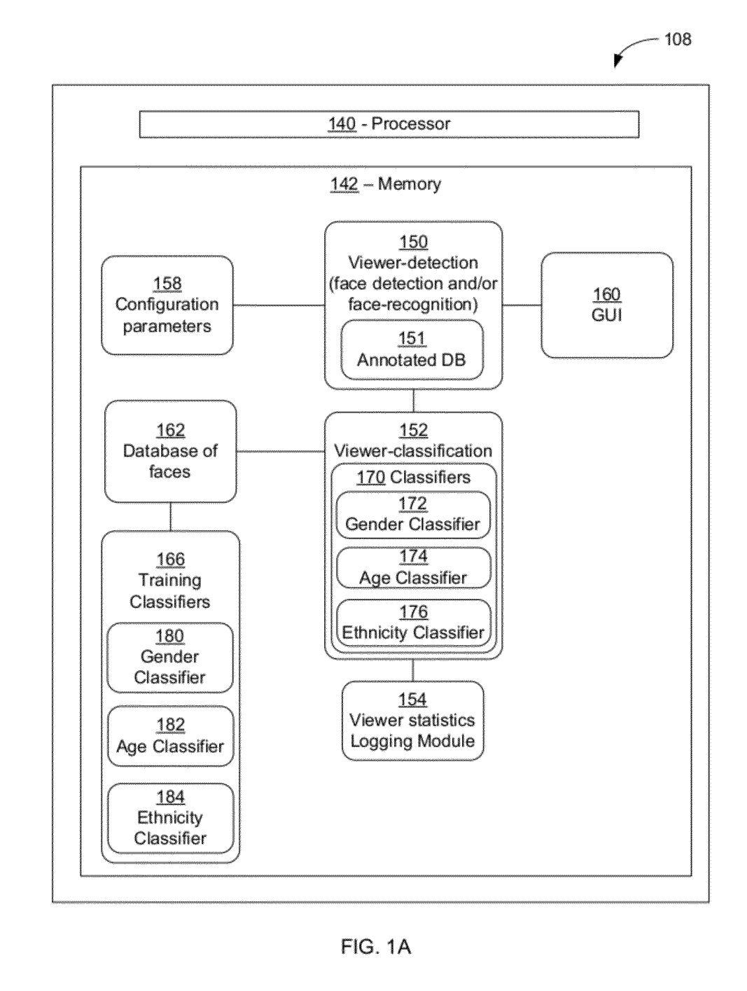

FIG. 1 is a content viewership system 100 according to one embodiment of the present disclosure. The content viewership system 100 includes a content distribution space 102, a content item 104, a camera 106, and a processing unit 108. The system 100 can detect one or more viewers 110 and classify each viewer 110. As used herein, the term viewer may include actual viewers as well as potential viewers (who may not actually view a content item 104) and may also be considered to include consumers or potential consumers. The detection information and/or classification information may be stored and/or used to determine viewership statistics for the distribution space 102 and/or content item 104.

The content distribution space 102 presents the content item 104. The content distribution space 102 illustrated is an advertisement sign of the type a viewer 110 might pass while walking through a public place, such as for example, an airport. In other embodiments the content distribution space may be a billboard, a store display, street furniture, a video monitor, or any device for delivering mass media content to a viewer 110 at in-door, in-store, and/or out-door locations. In the illustrated embodiment, the content item 104 may be an advertisement, such as for example, a soft drink advertisement.

The camera 106 and the processing unit 108 may be referred to as an audience measurement system 120. The camera 106 can be configured and positioned to capture images (still images and/or video) of a viewer 110 approaching or otherwise within viewing distance of the content distribution space 102. The image data can be communicated to the processing unit 108 and used to detect whether the viewer 110 views the content 104 and/or used to ascertain characteristics about the viewer 110. The processing unit 108 may also detect whether the viewer 110 actually views the content item 104 being displayed and may gather statistics about viewers of the content item 104.

The processing unit 108 can include a processor, a memory, input and output devices and computer executable instructions for processing image data received from the camera 106. The processing unit 108 processes the image data to both detect and classify the viewer 110. Computer vision algorithms may be used to process the image data. Specifically, as shown in FIG. 1A, the processing unit 108 may include a processor 140 and a memory 142. The memory 142 may include various software modules, including a viewer detection module 150, a viewer classification module 152, a viewer statistics logging module 154, a configuration parameters module 158, and a graphical user interface (GUI) module 160, a database of faces 162, and a training classifiers module 166.

The viewer detection module 150 may detect a viewer by performing face detection and/or recognition. The term “detection,” as used herein, means distinguishing a face from other aspects of received image data. The term “recognition,” as used herein, means recognizing a particular face and may encompass face tracking as a person moves within the field of view (FOV) of the camera and to track a view from the same person as continuous view from subsequent images and/or frames obtained by the camera. The viewer detection module 150 may include an annotated database 151, which may include sample images having various known facial structures and can be used by the viewer detection module to compare captured image data to know faces and/or facial structures to perform face detection.

The viewer detection module 150 may perform face detection using a face detection algorithm, such as for example, the Viola-Jones Computer Vision Object detection algorithm (“Viola Jones Algorithm”). The Viola-Jones Algorithm may include, at a high level, running an AdaBoost learning algorithm (or variant thereof) on a set of training images having positive and negative images to both distill a set of Haar-like features and train. The yielded classifiers can be combined appropriately into a cascade of classifiers. Captured images can then be processed to similarly distill Haar-like features. The captured images and/or Haar-like features can be compared to images in the annotated database 151. Additional details regarding the Viola-Jones Algorithm are available in Robust Real-Time Face Detection, Paul Viola and Michael Jones, International Journal of Computer Vision 57(2), pp. 137-154, 2004, which is hereby incorporated herein by reference in its entirety. Additional details regarding AdaBoost are available in AdaBoost and the Super Bowl of Classifiers: A Tutorial Introduction to Adaptive Boosting, Raul Rojas, 2009, which is hereby incorporated herein by reference in its entirety.

The viewer detection module 150 may also detect motion of a detected face, such as for example, when a passing viewer 110 turns his or her head toward the content. Motion detection may be accomplished using pixel differentiation algorithms. The viewer detection module 150 may further determine other aspects, such as for example, the line of sight of a viewer's eyes and a change of expression on the viewer's face in response to the content 104, to determine if the viewer is looking at and/or reacting to the content 104. The line of sight of a viewer's eyes may be determined by comparing the detected face to faces in the annotated database 151. The faces in the annotated database 151 may have known characteristics. By matching the detected face to one or more faces in the annotated database 151, for which the line of sight is known, the line of sight of the detected face can be known or at least approximated. For example, the annotated database 151 may include a number of different faces for which the line of sight of the face is directed to the camera. The different faces are stored in the annotated database 151 with an associated characteristic that the line of sight of the face is straight on, or directed to the camera. When the detected face has features (e.g., position of the pupil of the eyes relative to the rest of the eye, angle of the nose, proportions of visible area of the face on either side of the nose) corresponding with a characteristic (e.g., line of sight) and that match with the same features of a face in the annotated database 151, a conclusion can be drawn that the detected face has the same corresponding characteristic (e.g., line of sight) as the face in the annotated database 151.

The viewer classification module 152 may classify a detected face according to one or more classifications. For example, the viewer classification module 152 may perform gender classification, age classification, and ethnic classification. Viewer classification may be accomplished by comparing a detected face to faces in a database of faces 162 using a variety of classifiers 170. For example, to perform gender classification, the detected face in a captured frame may be passed through a gender classifier 172. The gender classifier 172 may identify features of a detected face that are associated with gender, such as for example, hair length, presence of facial hair, length of eye lashes, and the like. The detection of features and matching with faces in the database of faces 162 may utilize algorithms, such as for example, the SVM (Support Vector Machine) algorithm and the AdaBoost algorithm, and mathematical comparison calculations. A determination may be made whether the face is male or female based on comparing the detected face with images from the database of faces 162.

Similarly, to perform age classification, the detected face in a captured frame may be passed through an age classifier 174 that identifies features associated with age classification, such as for example, hair color, wrinkle patterns, and the like. The detection of age-related features and matching the features of the detected face with features of faces in the database of faces 162 may utilize algorithms, such as for example, AdaBoost and SVM, and other mathematical comparison calculations. A determination may be made whether the face is a child, youth, adult or senior based on comparing the detected face with images from the database of faces 162.

To perform ethnicity classification, the detected face in a captured frame may be passed through an ethnicity classifier 176 that identifies features associated with ethnicity classification, such as for example, skin pigmentation, face shape, facial feature shapes and size proportions, hair structure, and the like. The detection of ethnicity-related features and matching the features of the detected face with features of faces in the database of faces 162 may utilize algorithms, such as for example, AdaBoost and SVM, and other mathematical comparison calculations. A determination may be made as to the likely ethnicity of an individual based on comparing the detected face with images from the database of faces 162.

The database of faces 162 may be compiled using training classifiers 166, which may classify sample faces against which a detected face can be compared. The training classifiers may similarly include a gender classifier 180, an age classifier 182, and an ethnicity classifier 184. The training classifiers may be internal to the system 100, as reflected in FIG. 1A. In another embodiment, the training classifiers may be external to the system 100, allowing building of the database of faces 162 offline using processing power external to the processor 140 and other external resources. The database of faces 162, or updates to the database of faces, can then be uploaded to the processing unit 108.

Utilizing the AdaBoost algorithm for viewer classification, whether for gender classification, age classification, or ethnicity classification, may include: cropping the face detector output; resizing the cropped region of the image to an image size of 36*36 pixels; performing histogram equalization on the resized image utilizing appropriate input files. One input file may be Model files, which may contain the following: Rectangular Haar-like features, Weight of each feature (wt), and Threshold (th). As an example, AdaBoost algorithm implementation for gender classification may include the following steps:

Equalize the image

Compute integral image

Perform the following for all the features in sequence:
i. Compute the feature value (fv)
ii. If (fv>=0) sum+=wt

If(sum>th) output=male else output=female

Utilizing the SVM algorithm for viewer classification, whether for gender classification, age classification, or ethnicity classification, may include: cropping the face detector output; resizing the cropped region of the image to an image size of 36*36 pixels; performing histogram equalization on the resized image; and normalizing the pixel values between −1 and 1 independent of the pixel values in the image. Testing an SVM implementation may include two input files: a Scale (intensity) file and a Model (classifier) file. The Scale file may contain the maximum and minimum value for each pixel for normalization The Model file may contain: gamma, rho, support vectors (SV), and vector coefficient (vco) for each SV. As an example, SVMt algorithm implementation for gender classification may include the following steps:

Equalize the image (face region)

Normalize (intensity) the image (face region)

Perform the following for all the support vectors in sequence:
i. dist=(Euclidean(SV, image))2
ii. v=exp(−dist*gamma)
iii. sum+=vco*v

if(sum>rho) output=male else output=female

In still other embodiments, other types of classification may be performed. For example, a detected viewer 110 may be classified according to characteristics, including, but not limited to, height, weight, clothing (i.e hat, pants/shorts, short/long sleeved shirt), and accessories (sunglasses, scarf, watch, briefcase, bike).

The data gathered by the viewer detection module 150 and the viewer classification module 152 can be stored by the viewer statistics logging module 154 in an audience statistics log and used to determine viewership statistics of the particular content distribution space 102 and/or the content item 104. For example, the stored data may include date, time, number of views, view duration, duration split (e.g., 1-3 seconds, 4-7 seconds, 8-10 seconds, above 10 seconds), gender split (male and female), age split (e.g, child, youth, adult & senior). This data can be transferred to a server for storing into database and to provide data mining operations for the user to generate various reports. Based on the stored data, reports can be generated corresponding to a given input, such as for example, date, hours, etc., in graphical format and tabular format. Reports can also be generated based on the actual play log. The data can also be analyzed to better determine effectiveness and price of content distribution space 102 as well as the effectiveness of a content item 104 and the types of content that are of interest to groups of viewers.

The configuration parameters module 158 may read from a configuration file, which contains parameters for program use. The configuration parameters module 158 may also provide an option to read the current configuration and to change any configuration parameters.

The graphical user interface (GUI) module 160 may allow displaying face detection in run time. The GUI module 160 may present to a user a GUI displaying the current image captured by the camera. As a face is detected in the current image, the GUI may display an indicator of the detected face. For example, the GUI may present a box around a detected face to indicate the area of the current image in which a viewer face is detected. The GUI presented to the user may also allow the user to configure various parameters and to initiate and/or terminate viewer detection and/or viewer classification. The GUI may also present viewer classification information. In particular, the GUI may present results of various viewer classification processes run on a detected face, such as for example, gender classification, age classification, and ethnicity classification. The GUI 160 may also present the statistics of detected faces. The GUI may present these statistics by numbers and graphs.

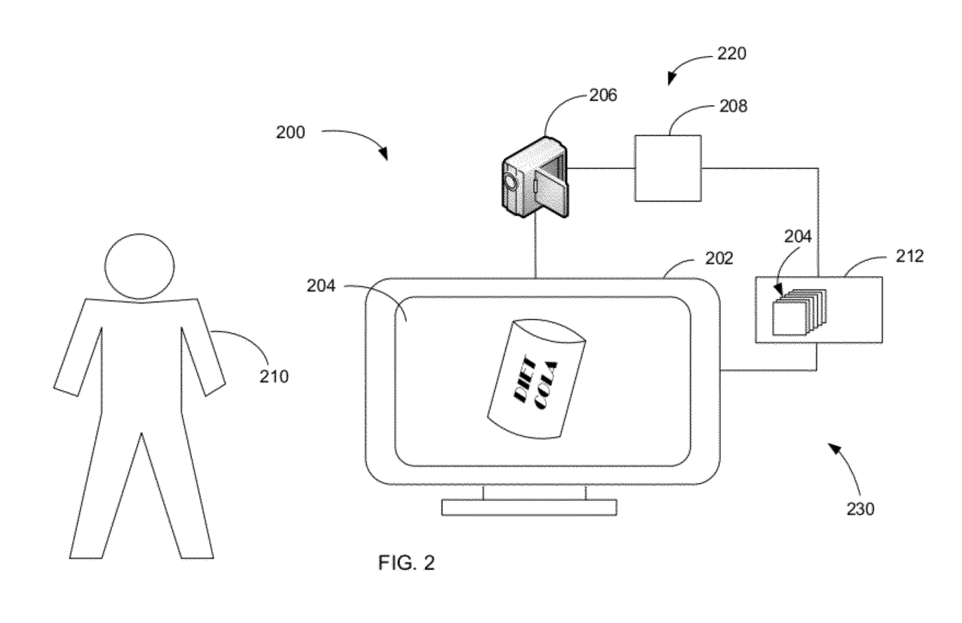

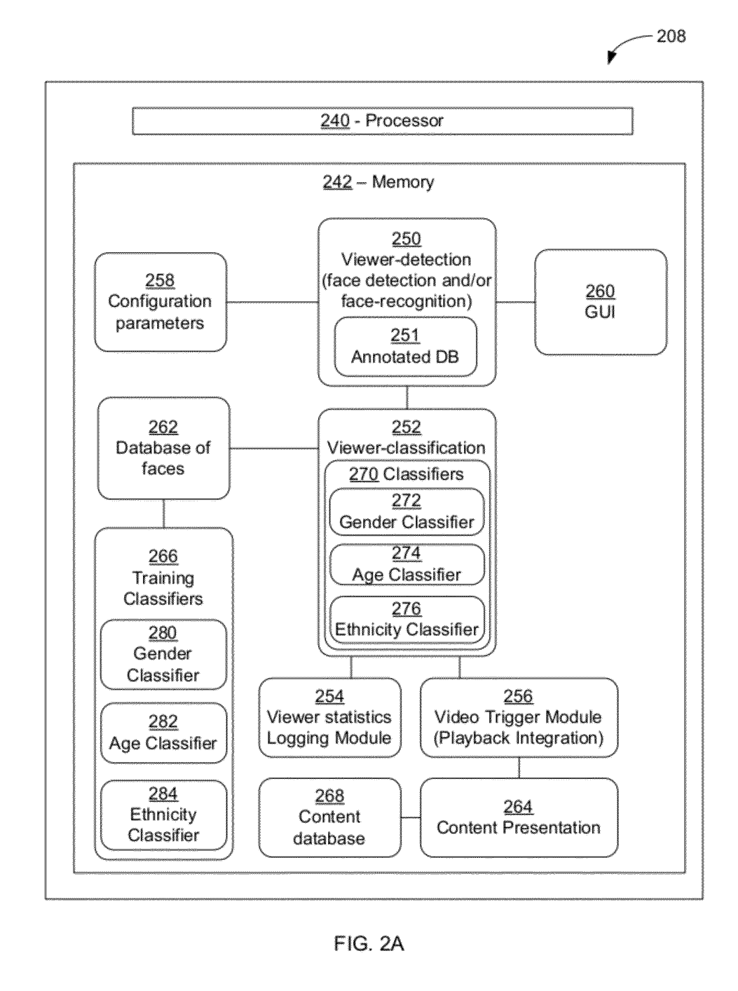

FIG. 2 is a content viewership system 200 that displays various content items depending on the viewer, according to one embodiment. The content viewership system 200 can include a content delivery system 230 and an audience measurement system 220. The content delivery system 230 may include a content distribution space 202, a plurality of content items 204, and a media player 212. The audience measurement system 220 may include a camera 206 and a processing unit 208. The content viewership system 200 can detect one or more viewers 210, classify each viewer, and then display content 204 on the content distribution space 202 that is targeted to the detected one or more viewers. The media player 212 provides content 204 that is targeted to the viewer based on viewer information gathered by the camera 202 and processing unit 208.

The content delivery system 230 displays one or more of the plurality of content items 204 to potential viewers 210 on the content distribution space 202. The content distribution space 202 illustrated in FIG. 2 is a video monitor. The content distribution space 202, for example, may be in a store window or part of a display of a product line. In another embodiment, the content distribution space 202 may be a digital sign for presenting various pieces of mass media content. The digital sign may be any form of digital signage. The term “digital signage” may encompass any form of electronic display that shows information, advertising and/or other messages that can be changed or adapted as needed with an intent to deliver a targeted message to a particular location at a given time. Examples of physical hardware of digital signage include LCD, LED, plasma displays, and projectors. The content distribution space 202 presents one of the plurality of content items 204 to potential viewers 210. In the illustrated embodiment, the displayed content item 204 may be an advertisement, such as for example, a soft drink advertisement.

In another embodiment, the content distribution space 202 may be capable of displaying a plurality of content items 204 simultaneously. The content distribution space 202 may further include speakers (not shown) to provide audio content. In another embodiment, the content distribution space 202 may further include audio outputs to connect to external speakers. The content items 204 may include, but are not limited to, images, video, audio, presentation slides, picture-in-picture, scrolling ticker, banners, and any other form of audio-visual content.

The content delivery system 230 may be capable of receiving inputs from audience measurement system 220 and decide accordingly which media content item 204 should play from a pool of one or more content items 204. To select corresponding media content from the pool of one or more content items 204, each content item 204 may have information associated with it, to characterize or otherwise classify the content item 204. The information could indicate that the content item 204 is for Male-Child, Male-Youth, Male-Adult, Male-Senior, etc. Also there may be other information indicating how the system should behave for more than one viewer of same gender or if different genders are viewing the content distribution space 202 at the same time. The pool of one or more content items 204 may be stored in a database of content.

In another embodiment, the content delivery system 230 may simply receive an appropriate content item 204 from the audience measurement system 220. In still another embodiment, the content delivery system 230 may receive an instruction from the audience measurement system 220 indicating which of the plurality of content items 204 to present.

The camera 206 and the processing unit 208 may be an audience measurement system 220, similar to the embodiment 100 of FIG. 1. The camera 206 is configured and positioned to capture images (still images and/or video) of a viewer 210 passing the distribution space 202. The image data can be communicated to the processing unit 208 and used to detect whether the viewer views the content 204 and to gather statistics about viewers of the content 204.

As in the embodiment of FIG. 1, the processing unit 208 of FIG. 2 can include a processor, a memory, input and output devices and computer executable instructions for processing image data received from the camera 206, and can process the image data to both detect a viewer and then classify the viewer. Computer vision algorithms may be used to process the image data. Specifically, as shown in FIG. 2A, the processing unit 208 may include a processor 240 and a memory 242. The memory 242 may include various software modules, including a viewer detection module 250, a viewer classification module 252, a viewer statistics logging module 254, a video trigger module 256, a configuration parameters module 258, a graphical user interface (GUI) module 260, a database of faces 262, a content presentation module 264, a training classifiers module 266, and a content database 268.

The viewer detection module 250 may include an annotated database 251 of faces and may detect a viewer by performing face detection and/or recognition, as described above with reference to FIG. 1A. Similarly, the viewer classification module 252 may perform gender classification, age classification, ethnic classification, as described above with reference to FIG. 1A. In particular, the viewer classification module 252 may identify features of a detected face that are associated with gender, age, or ethnicity and match the features with faces in the database of faces 262 utilizing algorithms, such as for example, the SVM (Support Vector Machine) algorithm and the AdaBoost algorithm, and mathematical comparison calculations. The viewer classification module 252 may include various classifiers 270, for example a gender classifier 272, an age classifier 274, and an ethnicity classifier 276, to perform aspects of the viewer classification.

The database of faces 262 may be compiled using training classifiers 266, which may classify sample faces against which a detected face can be compared. The training classifiers may similarly include a gender classifier 280, an age classifier 282, and an ethnicity classifier 284. The training classifiers may be internal to the system 200, as reflected in FIG. 1A. In another embodiment, the training classifiers may be external to the system 200, allowing building of the database of faces 262 offline using processing power external to the processor 240 and other external resources. The database of faces 262, or updates to the database of faces, can then be uploaded to the processing unit 208.

The data gathered by the viewer detection module 250 and the viewer classification module 252 can be stored by the viewer statistics logging module 254 in an audience statistics log and used to determine viewership statistics of the particular content distribution space 202 and/or content item 204, as described above with reference to FIG. 1A. The data gathered by the viewer detection module 250 and the viewer classification module 252 is primarily based on date and time. The content display log may be also based on date and time. Using date and time as primary values, software may integrate these two logs into one single log that combines both the content display log and the audience statistics log. From this combined log, viewer statistics can be obtained for the actual content played. In the cases where content play log is not available, then the viewership statistics will be available based on date and time only.

The video trigger module 256 may be configured to provide input to a content presentation module 264. The video trigger module may analyze the available plurality of content items 204 in the content database 268, with their associated parameters, and choose the content item(s) 204 to be displayed based on the detected viewer profile. The video trigger module 256 may provide an indication to the content presentation module 264 as to the content item 204 that should be presented. In another embodiment, the video trigger module 256 may simply provide viewer detection data to the content presentation module 264, and the content presentation module 264 may analyze the available plurality of content items 204 in the content database 268, with their associated parameters, and choose the content item(s) 204 to be displayed based on the viewer detection data. In still another embodiment, the video trigger module 256 may be configured to trigger, for example, a content delivery system 222 to present a content item 204 based on a detected current viewer profile, for example, Male-Adult. The content item 204 and its associated configuration can be changed remotely, for example, at a server.

The content presentation module 264 may receive input from the video trigger module 256. If the content presentation module 264 does not receive any input from video trigger module 256, then it may continue to display its own scheduled content item 204. If the content presentation module 264 receives input from the video trigger module 256, then it may be configured to display the indicated particular content items. The content item presented can be based on gathered viewer information, as previously described. In another embodiment, the content presentation module 264 may provide to the media player a content item that is targeted to the detected viewer. The processing unit 208 may further include a content database 268 to store a plurality of content items 204 and their associated characteristics.

In another embodiment, the content presentation module 264 may provide instructions to the content delivery system 230 (and/or to the media player 212 of the content delivery system 230) as to the content item, from among the plurality of content items, that should be presented to a detected viewer. The content item presented can be based on gathered viewer information. In another embodiment, the content presentation module may provide to the media player a content item that is targeted to the detected viewer.

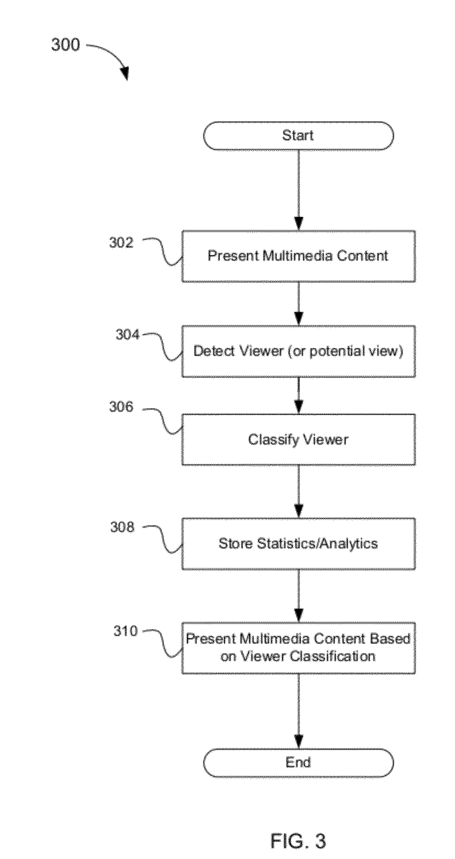

FIG. 3 is a high-level flow diagram of a method 300 for gathering content viewership statistics, according to one embodiment. A piece of OOH mass media content is presented 302, for example, on a billboard, monitor, or other content distribution space. A viewer is detected 304. A detected viewer is then classified 306, or otherwise grouped based on such characteristics as gender, age, ethnicity, and the like. The gathered viewership statistics are stored 308 and analyzed. The stored viewership statistics can be used to identify targeted content based on the viewer characteristics and present 310 that targeted content.

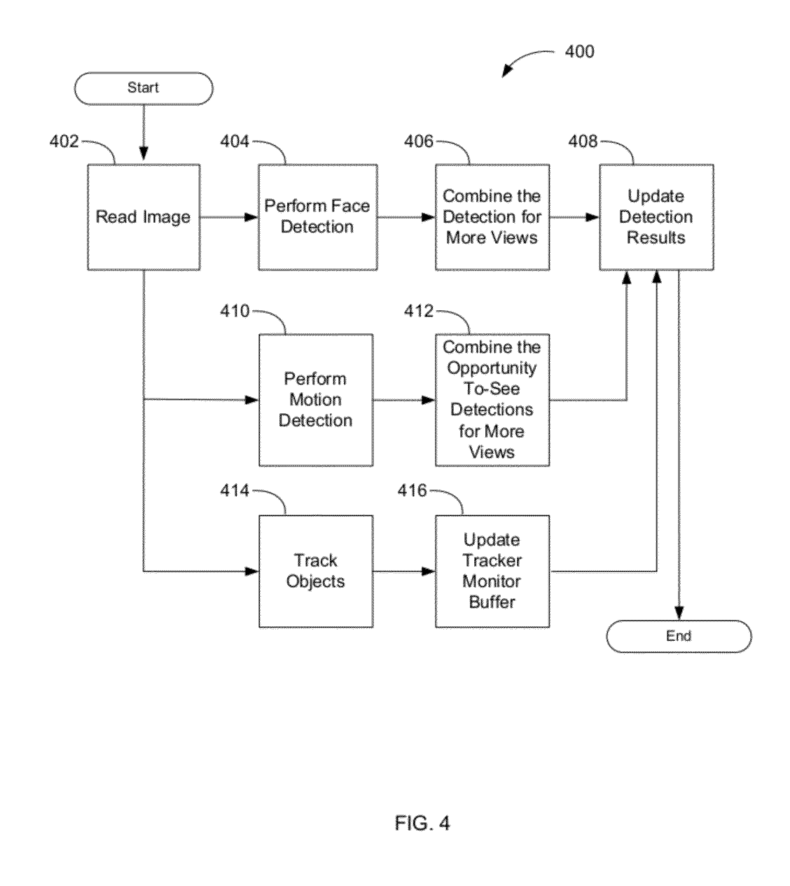

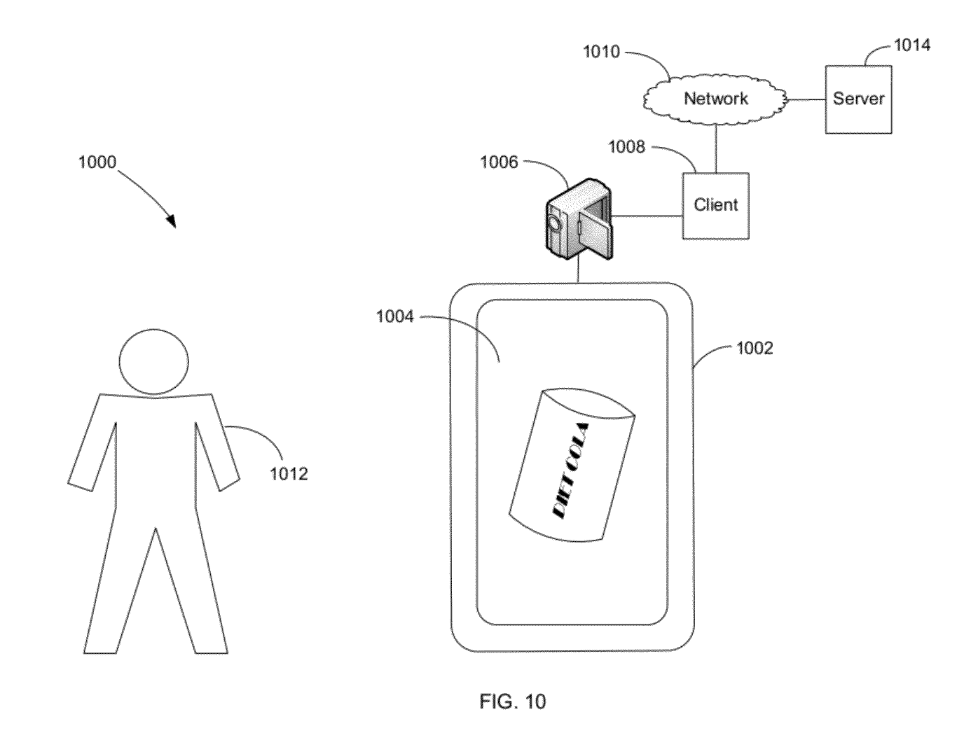

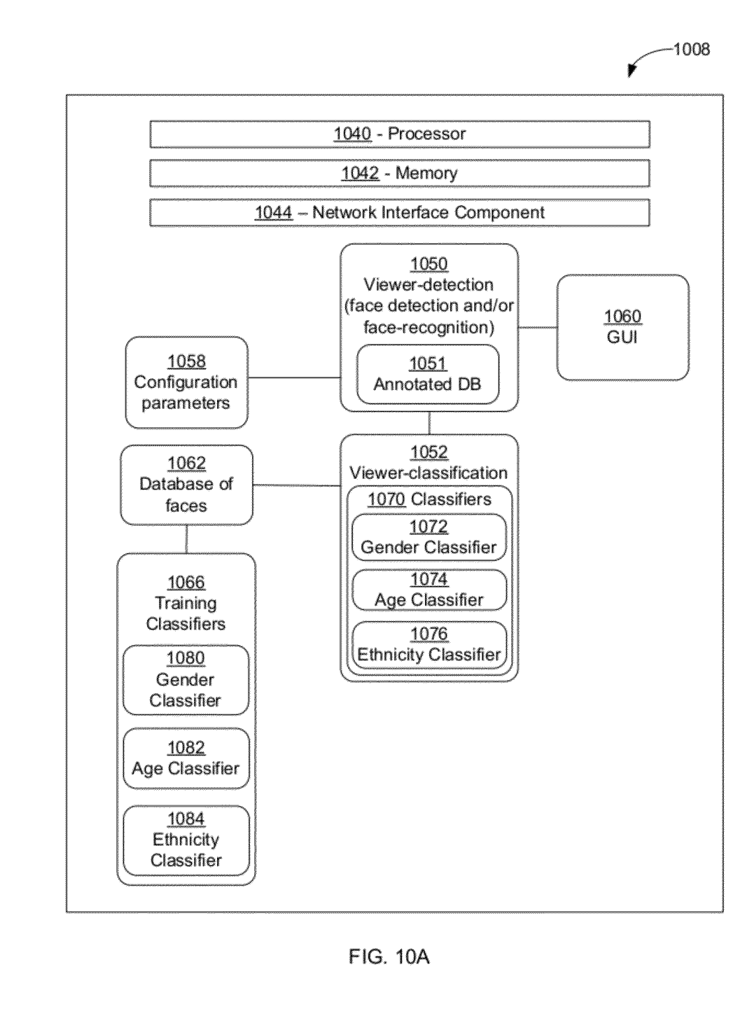

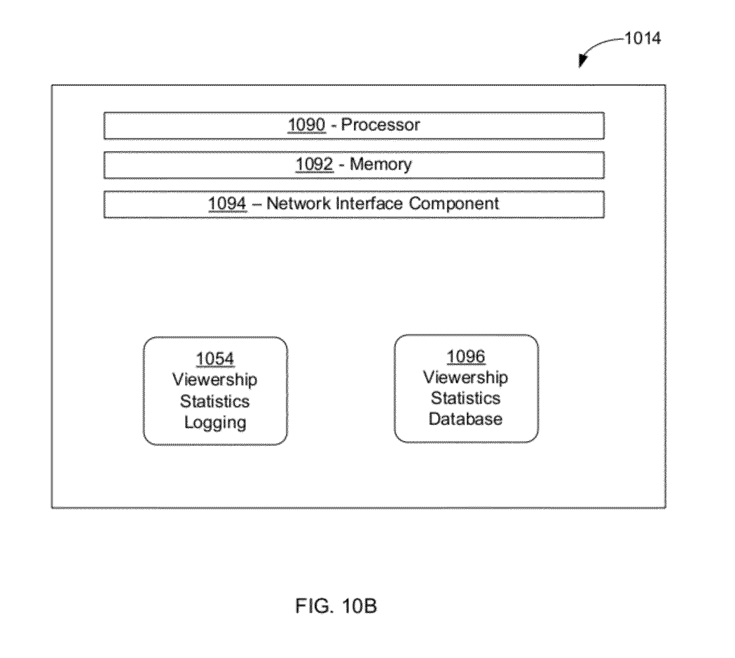

FIG. 4 is flow diagram of a method 400 for detecting a viewer, according to one embodiment. A viewer may be detected by one or more of face detection, upper body detection, motion detection, and object tracking. An image is read 402, for example, from a camera, and stored, for example, in a buffer. The buffer may be local, on a client processing unit, or may be remote on a server processing unit (see, for example, FIG. 10). Face detection 404 may be performed using, for example, the Viola-Jones Algorithm. The results of the face detection 404 can be combined 406 with the results of detection for more views. For example, a viewer may rotate relative to the camera, such that multiple perspectives and/or angles of the viewer's face may be presented to the camera. Combining these views can improve detection accuracy. As another example, multiple views of a viewer may be captured by multiple cameras, and these multiple angles and perspectives can be combined. As still another example, if two detections have an overlapping area above a threshold, one of the detections may be rejected, thus combining the two detections into one. The face detection results can be updated 408 and stored, for example, in a detection buffer.

Motion detection 410, may also be performed to detect motion of the detected face and or motion within a camera view. Motion detection 410 may include, for example, using pixel differentiation algorithms. Motion detection 410 may be performed substantially concurrent with face detection 404. In another embodiment, motion detection 404 and face detection 410 can be performed non-concurrently. Again, multiple detections and/or views can be combined 412, by capturing multiple images of multiple perspective presentations of the viewer's face, multiple camera angles, and/or rejecting one of two detections that have an overlapping area above a threshold. Moreover, motion detections 410 can be combined 412 with opportunity to see detections. An opportunity-to-see detection may be characterized as a detected face for which the presented content is within the viewer's range of vision, regardless of the viewer's line of sight. The opportunity to see detections are mainly for detecting people passing by (without looking at) the camera. The motion detection results and opportunity-to-see detection results can be updated 408 and stored, for example, in a detection buffer. Then the method 400 may end.

Tracking 414 of objects, such as a viewer, from one captured image (or frame) to another can also be accomplished, such as by performing the Mean Shift Algorithm. The results of tracking 414 are also updated 416 in the tracker monitor buffer. The tracker monitor buffer may be used to keep information of tracking an object. The information may include whether an object is moving out of the range of view (ROV) or tracking of an object is otherwise lost. Results of tracking may be updated 408 in the detection results. As can be appreciated, face detection 404, motion detection 410, and tracking 412, and the corresponding combining of views and updating results can happen substantially concurrently (or in parallel).

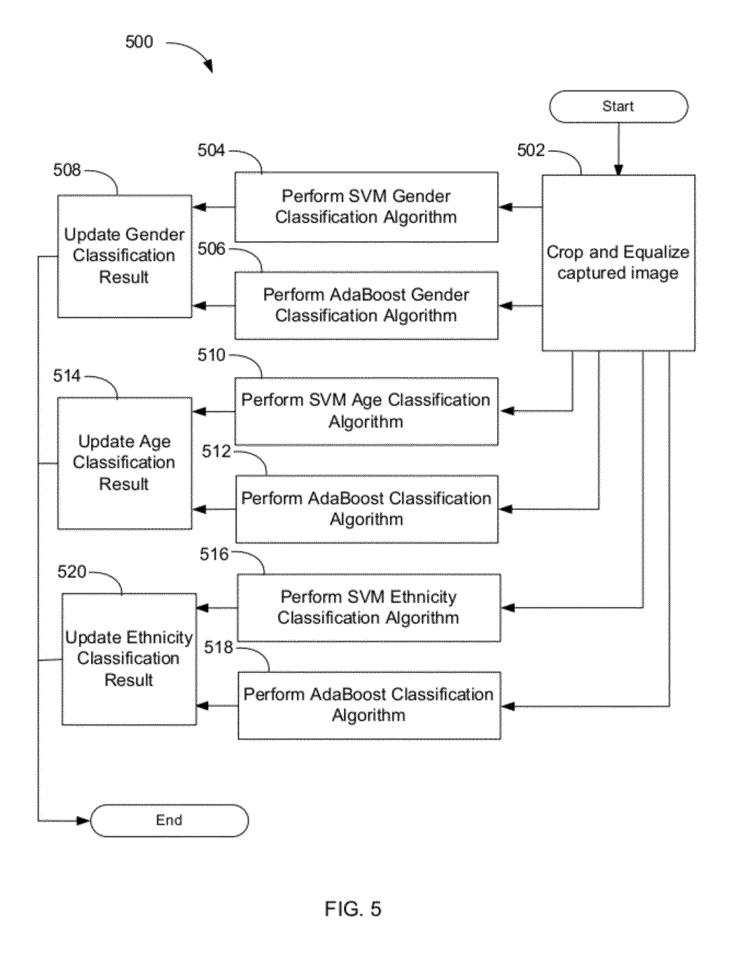

FIG. 5 is a flow diagram of a method 500 for classifying a viewer, according to one embodiment. Classifying a detected viewer may include gender classification and age classification. The image that is read 402 (see FIG. 4) may be cropped and equalized 502. The image may be cropped substantially near the border of the detected face, such that the detected face substantially fills the remainder of the image. The image may be equalized, meaning it may be resized to a standard size for identification of classification features and/or for comparison to images in the database of faces. In other words, a face that may be detected at a relatively far distance from the camera may appear small in the captured image, and thus the cropped image that results may be relatively small compared to faces in the database of faces. The size disparity may decrease the quality of a comparison between the detected face (and/or any identified attributes) and the faces in the database of faces (and/or any corresponding attributes). Equalizing the image may enlarge the image and thereby improve the quality of comparison. Similarly, a face detected relatively close to the camera may appear quite large in the captured image and thus the cropped image that results may be relatively large compared to faces in the database of faces. Equalizing the image may reduce the cropped image size and thereby improve the quality of a comparison.

The cropped and equalized image can be passed through one or more classification processes concurrently (i.e., substantially simultaneously or in parallel). These classification processes may include, for example, gender classification, age classification, and ethnicity classification. Gender classification may include one or more of performing a gender classification algorithm 504, such as SVM, as well as performing AdaBoost Gender Classification algorithm 506. These two classification algorithms may execute concurrently and produce independent results, and final gender detection results can be produced by either algorithm or a combined result from the two algorithms (if both give the same gender classification result). The gender classification result is then updated 508.

Age classification may include one or more of SVM age classification algorithm 510, as well as performing AdaBoost age classification algorithm 512. Again, the two classification algorithms may execute concurrently and produce independent results, and final age detection results can be produced by either algorithm or a combined result from the two algorithms (if both give the same age classification result). The age classification result is then updated 514.

Ethnicity classification may include one or more of SVM age classification algorithm 516, as well as performing AdaBoost ethnicity classification algorithm 518. Again, the two classification algorithms may execute concurrently and produce independent results, and final ethnicity detection results can be produced by either algorithm or a combined result from the two algorithms (if both give the same ethnicity classification result). The ethnicity classification result is then updated 520.

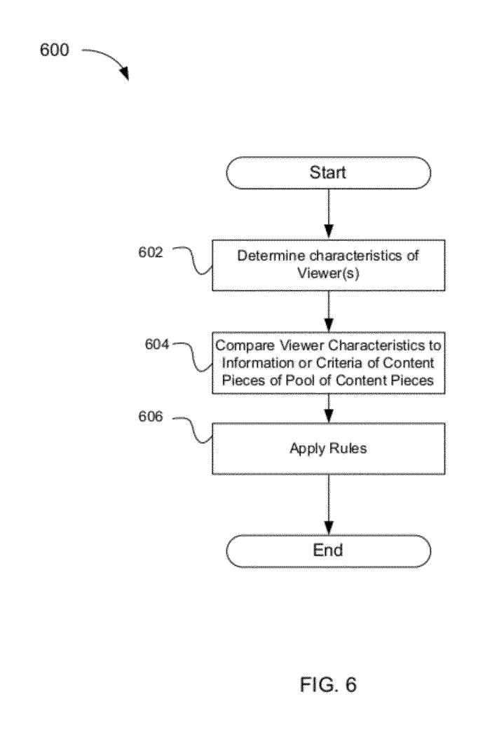

FIG. 6 is a flow diagram of a method 600 for identifying targeted content for a detected viewer and/or audience, according to one embodiment. A media content item may be identified from a pool of one or more content items based on criteria or information associated with each of the content items in the pool. The characteristics of the detected viewer(s) are determined 602, using, for example, the viewer characterization processes described above with reference to FIG. 5. The viewer characteristics are then compared 604 to criteria or information associated with the content items in the pool of content items. For example, the information could indicate that a content item is for Male-Child, Male-Youth, Male-Adult, Male-Senior, etc. One or more content items having associated criteria or information that matches the characteristics of the detected viewers may be identified as candidate content items. Rules may be applied 606, which may provide additional information indicating how the system should behave for more than one viewer of same gender or if different genders of viewers at the same time, and which may indicate which content item should be displayed if more than one candidate piece is identified.

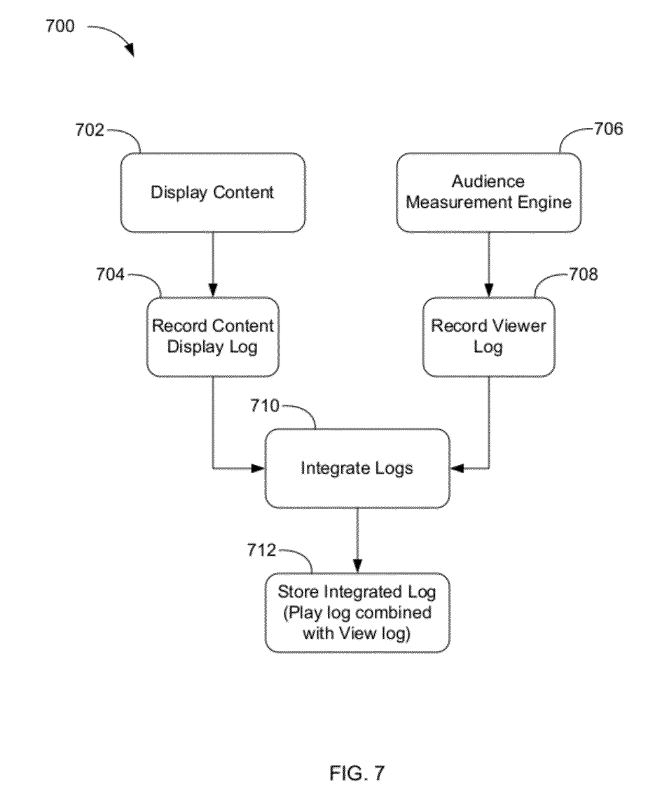

FIG. 7 is a high-level flow diagram of a method 700 for gathering content viewership statistics, according to another embodiment. A content delivery system on a first machine can display 702 one or more content items of a plurality of content items. A content display log of which content items are displayed is recorded 704 by the content delivery system, recording when each content item is presented based on time. The log may include date and/or time information indicating which content item is displayed at any given time. Concurrently, an audience measurement system can operate on the same machine, or on a separate machine associated with the content distribution space of the content delivery system. The audience measurement system may detect and classify 706 viewers of the content items. The statistics of detected viewers may be recorded 708 in an audience statistics log. The statistics of detected viewers may include audience metrics. The audience metrics that may be captured may include, but are not limited to, view count, view duration, OTS, gender split, age split. The data can be collected and stored in an audience statistics log based on time. A log integrator can auto integrate 710 data from the content display log and the audience statistics log, based on time. The integrated log can be stored 712.

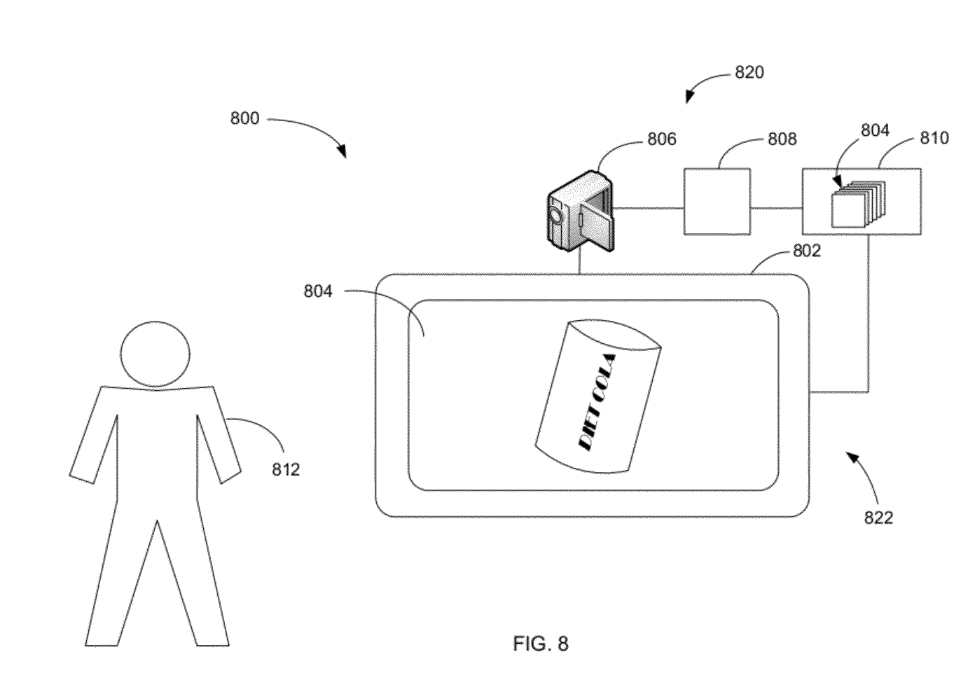

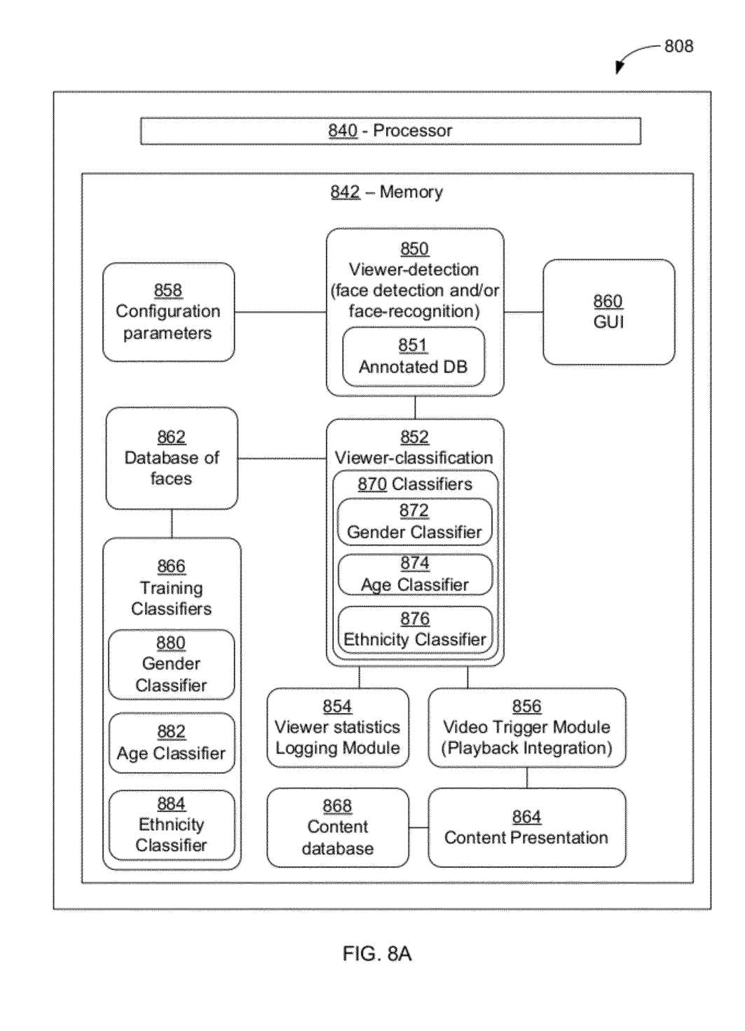

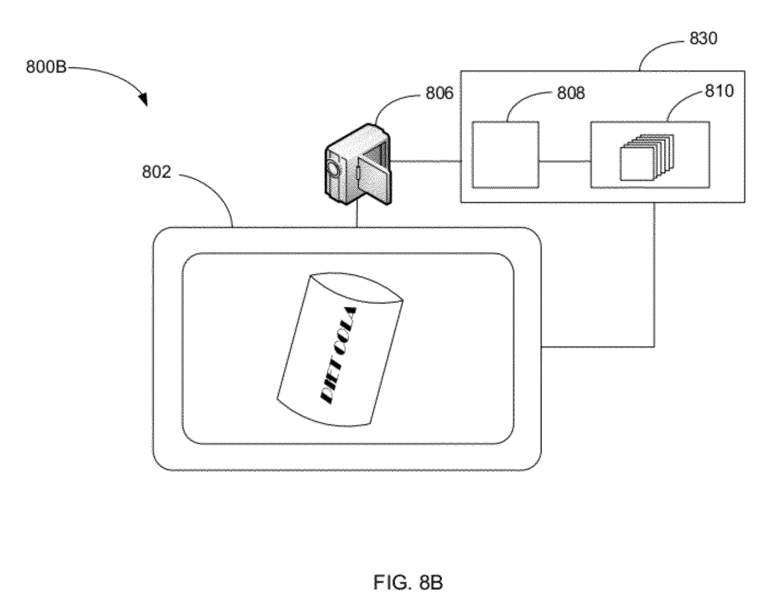

FIG. 8 is a system for delivering viewer-driven content 800, according to one embodiment of the present disclosure. The system 800 may include a content distribution space 802, a plurality of content items 804, a camera 806, a processing unit 808, and a media player 810. The system 800 can detect one or more viewers 812, classify each viewer 812, and then display on the content distribution space 802 one or more of the plurality of content items 804 that are targeted to an audience of consumers having characteristics of the detected one or more viewers 812. As used herein, the term viewer may include actual viewers as well as potential viewers (who may not actually view a content item 804) and may also be considered to include consumers or potential consumers. The media player 810 may deliver to the content distribution space 802 the content item 804 that is targeted to the one or more viewers 812 based on characteristics of the detected one or more viewers that are gathered by the camera 806 and processing unit 808. In the illustrated embodiment, the displayed content item 804 may be an advertisement, such as for example, a soft drink advertisement.

The camera 806 and the processing unit 808 may be referred to as an audience measurement system 820. The camera 806 can be configured and positioned to capture images (still images and/or video) of a viewer 812 approaching or otherwise within viewing distance of the content distribution space 802. The image data can be communicated to the processing unit 808 and used to ascertain characteristics about the viewer 812. The processing unit 808 may also detect whether the viewer 812 actually views the content item 804 being displayed and may gather statistics about viewers of the content item 804.

The processing unit 808 can include a processor, a memory, input and output devices and computer executable instructions for processing image data received from the camera 806. The processing unit 808 may process the image data to both detect a viewer and classify the viewer 812. Computer vision algorithms may be used to process the image data. Specifically, as shown in FIG. 8A, the processing unit 808 may include a processor 840 and a memory 842. The memory 842 may include various software modules, including a viewer detection module 850, a viewer classification module 852, a viewer statistics logging module 854, a video trigger module 856, a configuration parameters module 858, a graphical user interface (GUI) module 860, a database of faces 862, a content presentation module 864, a training classifiers module 866, and a content database 868.

The viewer detection module 850 may detect a viewer by performing face detection and/or recognition. The term “detection,” as used herein, means distinguishing a face from other aspects of received image data. The term “recognition,” as used herein, means recognizing a particular face and may encompass face tracking as a person moves within the field of view (FOV) of the camera and tracking a view from the same person as a continuous view from subsequent images and/or frames obtained by the camera. The viewer detection module 850 may include an annotated database 851, which may include sample images having various known facial structures and can be used by the viewer detection module to compare captured image data to know faces and/or facial structures to perform face detection.

The viewer detection module 850 may perform face detection using a face detection algorithm, such as for example, the Viola-Jones Computer Vision Object detection algorithm (“Viola Jones Algorithm”), as described above.

The viewer detection module 850 may also detect motion of a detected face, such as for example, when a passing viewer turns his or her head toward the content. Motion detection may be accomplished using pixel differentiation algorithms. The viewer detection module 850 may further determine other aspects, such as for example, the line of sight of a viewer's eyes and a change of expression on the viewer's face in response to viewing the content 804, to determine if the viewer is looking at and/or reacting to the content 804. The line of sight of a viewer's eyes may be determined by comparing the detected face to faces in the annotated database 851. The faces in the annotated database 851 may have known characteristics. By matching the detected face to one or more faces in the annotated database 851, for which the line of sight is known, the line of sight of the detected face can be known or at least approximated. For example, the annotated database 851 may include a number of different faces for which the line of sight of the face is directed to the camera. The different faces are stored in the annotated database 851 with an associated characteristic that the line of sight of the face is straight on, or directed to the camera. When the detected face has features (e.g., position of the pupil of the eyes relative to the rest of the eye, angle of the nose, proportions of visible area of the face on either side of the nose) corresponding with a characteristic (e.g., line of sight) and that match with the same features of a face in the annotated database 851, a conclusion can be drawn that the detected face has the same corresponding characteristic (e.g., line of sight) as the face in the annotated database 851.

The viewer classification module 852 may classify a detected face according to one or more classifications. For example, the viewer classification module 852 may perform gender classification, age classification, and ethnic classification. Viewer classification may be accomplished by comparing a detected face to faces in a database of faces 862 using a variety of classifiers 870. For example, to perform gender classification, the detected face in a captured frame may be passed through a gender classifier 872. The gender classifier 872 may identify features of a detected face that are associated with gender, such as for example, hair length, presence of facial hair, length of eye lashes, and the like. The detection of features and matching with faces in the database of faces 862 may utilize algorithms, such as for example, the SVM (Support Vector Machine) algorithm and the AdaBoost algorithm, and mathematical comparison calculations. A determination may be made whether the face is male or female based on comparing the detected face with images from the database of faces 862.

Similarly, to perform age classification, the detected face in a captured frame may be passed through an age classifier 874 that identifies features associated with age classification, such as for example, hair color, wrinkle patterns, and the like. The detection of age-related features and matching the features of the detected face with features of faces in the database of faces 862 may utilize algorithms, such as for example, AdaBoost and SVM, and other mathematical comparison calculations. A determination may be made whether the face is a child, youth, adult or senior based on comparing the detected face with images from the database of faces 862.

To perform ethnicity classification, the detected face in a captured frame may be passed through an ethnicity classifier 876 that identifies features associated with ethnicity classification, such as for example, skin pigmentation, face shape, facial feature shapes and size proportions, hair structure, and the like. The detection of ethnicity-related features and matching the features of the detected face with features of faces in the database of faces 862 may utilize algorithms, such as for example, AdaBoost and SVM, and other mathematical comparison calculations. A determination may be made as to the likely ethnicity of an individual based on comparing the detected face with images from the database of faces 862.

The database of faces 862 may be compiled using training classifiers 866, which may classify sample faces against which a detected face can be compared. The training classifiers may similarly include a gender classifier 880, an age classifier 882, and an ethnicity classifier 884. The training classifiers may be internal to the system 800, as reflected in FIG. 8A. In another embodiment, the training classifiers may be external to the system 800, allowing building of the database of faces 862 offline using processing power external to the processor 840 and other external resources. The database of faces 862, or updates to the database of faces, can then be uploaded to the processing unit 808.

In still other embodiments, other types of classification may be performed. For example, a detected viewer 812 may be classified according to characteristics, including, but not limited to, height, weight, clothing (e.g., hat, pants/shorts, short/long sleeved shirt), and accessories (e.g., sunglasses, scarf, watch, earphones, briefcase, bike, skateboard).

The data gathered by the viewer detection module 850 and the viewer classification module 852 can be stored by the viewer statistics logging module 854 in an audience statistics log and used to determine viewership statistics of the particular content distribution space 802 and/or the content item 804. For example, the stored data may include date, time, number of views, view duration, duration split (e.g., 8-3 seconds, 4-7 seconds, 8-10 seconds, above 80 seconds), gender split (male and female), age split (e.g., child, youth, adult & senior). This data can be transferred to a server for storing into a database and to provide data mining operations for the user to generate various reports. Based on the stored data, reports can be generated corresponding to a given input, such as for example, date, hours, etc., in graphical format and tabular format. Reports can also be generated based on the actual play log. The data can also be analyzed to better determine effectiveness and price of content distribution space 802 as well as the effectiveness of a content item 804 and the types of content that are of interest to groups of viewers.

The video trigger module 856 may be configured to provide input to a content presentation module 864. The video trigger module may analyze the available plurality of content items 804 in the content database 868, with their associated parameters, and choose the content item(s) 804 to be displayed based on the detected viewer profile. The video trigger module 856 may provide an indication to the content presentation module 864 as to the content item 804 that should be presented. In another embodiment, the video trigger module 856 may simply provide viewer detection data to the content presentation module 864, and the content presentation module 864 may analyze the available plurality of content items 804 in the content database 868, with their associated parameters, and choose the content item(s) 804 to be displayed based on the viewer detection data. In still another embodiment, the video trigger module 856 may be configured to trigger, for example, a content delivery system 822 to present a content item 804 based on a detected current viewer profile, for example, Male-Adult. The content item 804 and its associated configuration can be changed remotely, for example, at a server.

The content presentation module 864 may receive input from the video trigger module 856. If the content presentation module 864 does not receive any input from video trigger module 856, then it may continue to display its own scheduled content item 804. If the content presentation module 864 receives input from the video trigger module 856, then it may be configured to display the indicated particular content item. The content item presented can be based on gathered viewer information, as previously described. In another embodiment, the content presentation module 864 may provide to the media player a content item that is targeted to the detected viewer. The processing unit 808 may further include a content database 868 to store a plurality of content items 804 and their associated characteristics.

The configuration parameters module 858 may read from a configuration file, which contains parameters for program use. The configuration parameters module 858 may also provide an option to read the current configuration and to change any configuration parameters.

The graphical user interface (GUI) module 860 may allow displaying face detection in run time. The GUI module 860 may present to a user a GUI displaying the current image captured by the camera. As a face is detected in the current image, the GUI may display an indicator of the detected face. For example, the GUI may present a box around a detected face to indicate the area of the current image in which a viewer face is detected. The GUI presented to the user may also allow the user to configure various parameters and to initiate and/or terminate viewer detection and/or viewer classification. The GUI may also present viewer classification information. In particular, the GUI may present results of various viewer classification processes run on a detected face, such as for example, gender classification, age classification, and ethnicity classification. The GUI 860 may also present the statistics of detected faces. The GUI may present these statistics by numbers and graphs.

Referring again to FIG. 8, the content distribution space 802 and the media player 810 may be referred to as a content delivery system 822. The content delivery system 822 may receive input regarding the characteristics of an audience and present content to that audience based on those characteristics. In this manner, the system 800 provides viewer-driven mass media content to viewers.

The content distribution space 802 can be a video monitor as shown in FIG. 8. The content distribution space 802, for example, may be in a store window or part of a display of a product line. In another embodiment, the content distribution space 802 may be a digital sign for presenting various pieces of mass media content. In other embodiments, the content distribution space 802 can be electronic and/or digital signage, a rotating or scrolling sign, or any other content display capable of displaying one or more content items at indoor, in-store, and/or outdoor locations The content distribution space 802 may be capable of displaying a single content item 804. In another embodiment, the content distribution space 802 may be capable of displaying a plurality of content items 804 simultaneously. The content distribution space 802 may further include speakers (not shown) to provide audio content. In another embodiment, the content distribution space 802 may further include audio outputs to connect to external speakers. The content items may include, but are not limited to, images, video, audio, presentation slides, picture-in-picture, scrolling ticker, banners, and any other form of audio-visual content.

The media player 810 may be capable of receiving inputs from the processing unit 808 and decide accordingly which media content item should play from a pool of one or more content items 804. Accordingly, the data gathered by the viewer detection module 850 and viewer classification module 852 may be used by the media player 810 to identify one or more of the plurality of content items 804 that is targeted toward an audience, or at least one or more particular detected viewers 812 of an audience.

To select corresponding media content from the pool of one or more content items 804, each content item 804 may have information associated with it, to characterize or otherwise classify the content item 804. For example, the information could indicate that the content item 804 is for Male-Child, Male-Youth, Male-Adult, Male-Senior, etc. Also there may be other information indicating how the system should behave for more than one viewer of the same gender or of different genders viewing the content distribution space 802 at the same time. The pool of one or more content items 804 may be stored in a database of content.

In another embodiment, the media player 810 may simply receive an appropriate content item 804 from the processing unit 808.

In still another embodiment, the content delivery system 822 may receive an instruction from the audience measurement system 820 indicating which of the plurality of content items 804 to present.

The identified one or more content items 804 that are targeted to the detected viewer 812 can then be presented on the content distribution space 802. In this manner the content item 804 presented on the content distribution space 802 is driven by a viewer 812 of the content 804.

In another embodiment, the plurality of content items 804 may be stored on, or otherwise accessible to the processing unit 808. The processing unit 808 can process the data to determine characteristics of the viewer 812 and also identify one or more of the plurality of content items 804 that are targeted to the viewer 812. The processing unit 808 may supply an appropriate targeted content item 804 to the media player 810 for delivery to the content distribution space 802 to present to the viewer 812.

In still another embodiment, the processing unit 808 may include a content presentation module 864 (see FIG. 8A), which can provide instructions to the media player 810 as to a particular content item from among the plurality of content items 804 stored by the media player 810, that should be presented to a detected viewer 812.

In still another embodiment, the plurality of content items 804 may be stored at a remote server, in a distributed model. The processing unit 808 may communicate viewer characteristics to the remote server and/or retrieve one or more of the plurality of content items 804 that are targeted to the viewer 812 from the remote server.

In still another embodiment, the plurality of content items 804 may include one or more emergency play-lists, which can be played in response to an indication of an emergency. For example, there may be an Amber-alert content item 804, which advises viewers that an Amber-alert has issued and information about the Amber-alert or where to obtain additional information. The Amber-alert information may be received, for example, from a central server, or may be obtained from the Internet. As another example, there may be one or more safety-instructions content items 804, such as how to proceed in the event of a fire. The media player may receive input from a fire alarm and may provide the fire instructions content item 804 when the fire alarm is activated.

As can be appreciated, the audience measurement system 820 and content delivery system 822 are not necessarily separate devices. The various components can be combined in any suitable manner. FIG. 8B illustrates an alternative embodiment of a system 800B in which the processing unit 808 and the media player 810 may be coupled in a single device 830 with inputs and outputs to couple to the camera 806 and the content distribution space 802. The single device 830 may further include other interfaces, such as network interfaces and/or wireless interfaces to communicate with other devices. For example, the single device 830 may be configured to connect with the Internet via a wired or wireless network interface card.

In still another embodiment, the media player 810 may be integrated with the processing unit 808 and the processing unit 808 may further include a content presentation module 864, as shown in FIG. 8A. The content presentation module 864 can provide instructions directly to the media player 810 as to the content item that should be presented to a detected viewer.

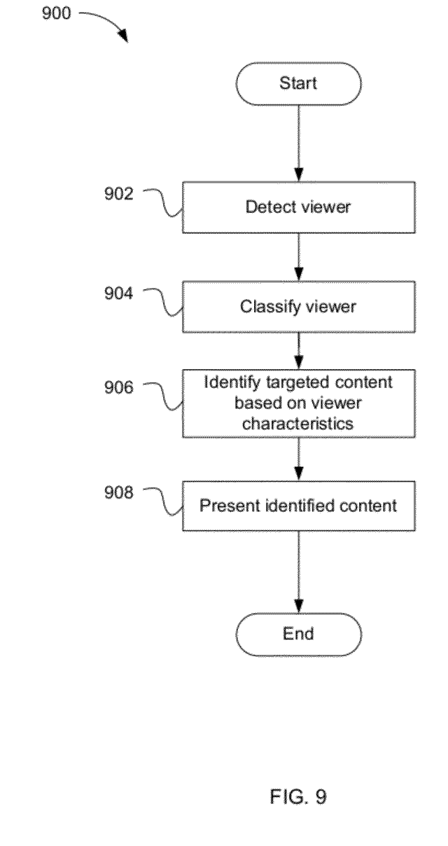

FIG. 9 is a high-level flow diagram of a method 900 for delivering viewer-driven content, according to one embodiment. A viewer is detected 902. A detected viewer is then classified 904, or otherwise grouped based on characteristics such as gender, age, ethnicity, and the like. The gathered viewer characteristics can be used to identify 906 a content item targeted to the identified viewer and the identified content item is presented 908 to the viewer. Viewer detection 902 and viewer classification 904 may be accomplished as described above with reference to FIGS. 4 and 5.

FIG. 10 is a content viewership system 1000 according to one embodiment of the present disclosure. The content viewership system 1000 includes a content distribution space 1002, a content item 1004, a camera 1006, a client processing unit 1008, and a server processing unit 1014. The content viewership system 1000 can detect one or more viewers 1012 and classify each viewer 1012. As used herein, the term viewer may include actual viewers as well as potential viewers (who may not actually view a content item 1004) and may also be considered to include consumers or potential consumers. The detection information and/or classification information may be stored and/or used to determine viewership statistics for the content distribution space 1002 and/or content item 1004.

The content distribution space 1002 presents the content item 1004. The content distribution space 1002 illustrated is an advertisement sign of the type a viewer 1012 might pass while walking through a public place, such as an airport. In other embodiments the content distribution space may be a billboard, a store display, street furniture, a video monitor, or any device for delivering mass media content to a viewer 1012 at in-door, in-store, and/or out-door locations. In the illustrated embodiment, the content item 1004 may be an advertisement, such as a soft drink advertisement.

The camera 1006 can be positioned and configured to capture images (still images and/or video) of a viewer 1012 approaching or otherwise within viewing distance of the content distribution space 1002. The image data is communicated to the client processing unit 1008 and/or server processing unit 1014 and used to detect whether the viewer 1012 views the content item 1004. The image data can also be used to ascertain characteristics about the viewer 1012. Information regarding viewership obtained by the client processing unit 1008 can be communicated to the server processing unit 1014 via a network 1010, such as the Internet. The information communicated to the server processing unit 1014 can be used to gather statistics about viewers of the content item 1004.

The client processing unit 1008 can include a processor, a memory, input and output devices and computer executable instructions for processing image data received from the camera 1006. The client processing unit 1008 processes the image data to both detect a viewer 1012 and classify the viewer 1012. Computer vision algorithms may be used to process the image data. Specifically, as shown in FIG. 10A, the client processing unit 1008 may include a processor 1040, memory 1042, a network interface component 1044, and various other components that may be implemented in hardware, software, or a combination thereof, including a viewer detection component 1050, a viewer classification component 1052, a configuration parameters component 1058, a graphical user interface (GUI) component 1060, a database of faces 1062, and a training classifiers component 1066. As can be appreciated, some or all of these components may be found in the server processing unit 1014, as will be explained, to shift the amount of data processing from the client side to the server side.

The viewer detection component 1050 may detect a viewer by performing face detection and/or recognition. The term “detection,” as used herein, means distinguishing a face from other aspects of received image data. The term “recognition,” as used herein, means recognizing a particular face and may encompass face tracking as a person moves within the field of view (FOV) of the camera and encompass tracking a view from the same person as continuous view from subsequent images and/or frames obtained by the camera. The viewer detection component 1050 may include an annotated database 1051, which may include sample images having various known facial structures and can be used by the viewer detection component 1050 to compare captured image data to known faces and/or facial structures to perform face detection.

The viewer detection component 1050 may perform face detection using a face detection algorithm, such as the Viola-Jones Computer Vision Object detection algorithm (“Viola Jones Algorithm”), as described above.

The viewer detection component 1050 may also detect motion of a detected face, such as when a passing viewer 1012 turns his or her head toward the content. Motion detection may be accomplished using pixel differentiation algorithms. The viewer detection component 1050 may further determine other aspects, such as the line of sight of a viewer's eyes and a change of expression on the viewer's face in response to the content item 1004, to determine if the viewer is looking at and/or reacting to the content item 1004. The line of sight of a viewer's eyes may be determined by comparing the detected face to faces in the annotated database 1051. The faces in the annotated database 1051 may have known characteristics. By matching the detected face to one or more faces in the annotated database 1051, for which the line of sight is known, the line of sight of the detected face can be known or at least approximated. For example, the annotated database 1051 may include a number of different faces for which the line of sight of the face is directed to the camera. The different faces are stored in the annotated database 1051 with an associated characteristic that the line of sight of the face is straight on, or directed to the camera. When the detected face has features (e.g., position of the pupil of the eyes relative to the rest of the eye, angle of the nose, proportions of visible area of the face on either side of the nose) corresponding with a characteristic (e.g., line of sight) and that match with the same features of a face in the annotated database 1051, a conclusion can be drawn that the detected face has the same corresponding characteristic (e.g., line of sight) as the face in the annotated database 1051.

The viewer classification component 1052 may classify a detected face according to one or more classifications. For example, the viewer classification component 1052 may perform gender classification, age classification, and ethnic classification. Viewer classification may be accomplished by comparing a detected face to faces in a database of faces 1062 using a variety of classifiers 1070. For example, to perform gender classification, the detected face in a captured frame may be passed through a gender classifier 1072. The gender classifier 1072 may identify features of a detected face that are associated with gender, such as hair length, presence of facial hair, length of eye lashes, and the like. The detection of features and matching with faces in the database of faces 1062 may utilize algorithms, such as the SVM (Support Vector Machine) algorithm and the AdaBoost algorithm, and mathematical comparison calculations. A determination may be made whether the face is male or female based on comparing the detected face with images from the database of faces 1062.

Similarly, to perform age classification, the detected face in a captured frame may be passed through an age classifier 1074 that identifies features associated with age classification, such as hair color, wrinkle patterns, and the like. The detection of age-related features and matching the features of the detected face with features of faces in the database of faces 1062 may utilize algorithms, such as AdaBoost and SVM, and other mathematical comparison calculations. A determination may be made whether the face is a child, youth, adult or senior based on comparing the detected face with images from the database of faces 1062.

To perform ethnicity classification, the detected face in a captured frame may be passed through an ethnicity classifier 1076 that identifies features associated with ethnicity classification, such as skin pigmentation, face shape, facial feature shapes and size proportions, hair structure, and the like. The detection of ethnicity-related features and matching the features of the detected face with features of faces in the database of faces 1062 may utilize algorithms, such as AdaBoost and SVM, and other mathematical comparison calculations. A determination may be made as to the likely ethnicity of an individual based on comparing the detected face with images from the database of faces 1062.

The database of faces 1062 may be compiled using training classifiers 1066, which may classify sample faces against which a detected face can be compared. The training classifiers may similarly include a gender classifier 1080, an age classifier 1082, and an ethnicity classifier 1084. The training classifiers may be internal to the content viewership system 1000, for example, the client processing unit 1008, as reflected in FIG. 10A. In another embodiment, the training classifiers may be external to the content viewership system 1000, allowing building of the database of faces 1062 offline using processing power external to the processor 1040 and other external resources. The database of faces 1062, or updates to the database of faces, can then be uploaded to the client processing unit 1008.

Utilizing the AdaBoost algorithm for viewer classification, whether for gender classification, age classification, or ethnicity classification, may include: cropping the face detector output; resizing the cropped region of the image to an image size of 36*36 pixels; performing histogram equalization on the resized image utilizing appropriate input files. One input file may be a Model file, which may contain the following: Rectangular Haar-like features, Weight of each feature (wt), and Threshold (th). As an example, AdaBoost algorithm implementation for gender classification may include the following steps:

Equalize the image

Compute integral image

Perform the following for all the features in sequence:
i. Compute the feature value (fv)
ii. If (fv>=0) sum+=wt

If(sum>th) output=male else output=female

Utilizing the SVM algorithm for viewer classification, whether for gender classification, age classification, or ethnicity classification, may include: cropping the face detector output; resizing the cropped region of the image to an image size of 36*36 pixels; performing histogram equalization on the resized image; and normalizing the pixel values between −1 and 10 independent of the pixel values in the image. Testing an SVM implementation may include two input files: a Scale (intensity) file and a Model (classifier) file. The Scale file may contain the maximum and minimum value for each pixel for normalization The Model file may contain: gamma, rho, support vectors (SV), and vector coefficient (vco) for each SV. As an example, SVM algorithm implementation for gender classification may include the following steps:

Equalize the image (face region)

Normalize (intensity) the image (face region)

Perform the following for all the support vectors in sequence:
i. dist=(Euclidean(SV, image))2
ii. v=exp(−dist*gamma)
iii. sum+=vco*v

if(sum>rho) output=male else output=female

In still other embodiments, other types of classification may be performed. For example, a detected viewer 1012 may be classified according to characteristics, including, but not limited to, height, weight, clothing (i.e hat, pants/shorts, short/long sleeved shirt), and accessories (sunglasses, scarf, watch, briefcase, bike).

The configuration parameters component 1058 may read from a configuration file, which contains parameters for program use. The configuration parameters component 1058 may also provide an option to read the current configuration and to change any configuration parameters.

The graphical user interface (GUI) component 1060 may allow displaying face detection in real time. The GUI component 1060 may present to a user a GUI displaying the current image captured by the camera. As a face is detected in the current image, the GUI may display an indicator of the detected face. For example, the GUI may present a box around a detected face to indicate the area of the current image in which a viewer face is detected. The GUI presented to the user may also allow the user to configure various parameters and to initiate and/or terminate viewer detection and/or viewer classification. The GUI may also present viewer classification information. In particular, the GUI may present results of various viewer classification processes run on a detected face, such as gender classification, age classification, and ethnicity classification. The GUI 1060 may also present the statistics of detected faces. The GUI may present these statistics by numbers and graphs.

The server processing unit 1014 can include a processor, a memory, input and output devices and computer executable instructions for processing and/or storing image data and other data. The server processing unit 1014 processes image data and/or other data received from the client processing unit 1008. In the illustrated embodiment, the server processing unit 1014 receives viewership statistics from the client processing unit 1008 and processes and/or stores the viewership statistics.

Specifically, as shown in FIG. 10B, the server processing unit 1014 may include a processor 1090, memory 1092, a network interface component 1094, and various other components that may be implemented in hardware, software, or a combination thereof, including but not limited to a viewership statistics logging module 1054 and a viewer statistics database 1096. The data gathered by the viewer detection component 1050 and the viewer classification component 1052 of the server processing unit 1014 can be stored by the viewership statistics logging component 1054 in an audience statistics log or the viewer statistics database 1096 and used to determine viewership statistics of the particular content distribution space 1002 and/or the content item 1004. For example, the stored data may include date, time, number of views, view duration, duration split (e.g., 1-3 seconds, 4-7 seconds, 8-10 seconds, above 100 seconds), gender split (male and female), age split (e.g, child, youth, adult & senior). Data mining operation may be performed on the data stored in the viewership statistics database 1096 to generate various reports. Based on the stored data, reports can be generated corresponding to a given input, such as date, hours, etc., in graphical format and tabular format. The data can also be analyzed to better determine effectiveness and price of content distribution space 1002, as well as the effectiveness of a content item 1004 and the types of content that are of interest to groups of viewers.

As described above, a high-level flow diagram of a method 300 for gathering content viewership statistics is shown in FIG. 3. A piece of OOH mass media content is presented 302, for example on a billboard, monitor, or other content distribution space. A viewer is detected 304. A detected viewer is then classified 306, or otherwise grouped based on such characteristics as gender, age, ethnicity, and the like. The gathered viewership statistics are stored 308 and analyzed. The stored viewership statistics can be used to identify targeted content based on the viewer characteristics and present 310 that targeted content.

As can be appreciated, viewer detection 304 and or viewer classification 306 can be accomplished locally, on a client processing unit 1008 of FIG. 10 and/or remotely on a server processing unit 1014 of FIG. 10. In an application where the client is a dumb terminal, the client processing unit 1008 may communicate image data to a server processing unit 1014 for viewer detection 304 and/or viewer classification 306. For example, security application may desire that image data be communicated to a central location for monitoring, and the transmitted image data can be processed remotely and centrally to perform viewer detection 304 and viewer classification 306. In other applications, the client processing unit 1008 can perform substantially all image processing to perform viewer detection 304 and viewer classification 306 to gather viewership statistics. The client processing unit 1008 may then communicate the viewership statistics to the server processing unit 1014. The server processing unit 1014 may gather and store the viewership statistics from a plurality of client processing units 1008 and enable statistical analysis, data mining, report generation, and similar functions.

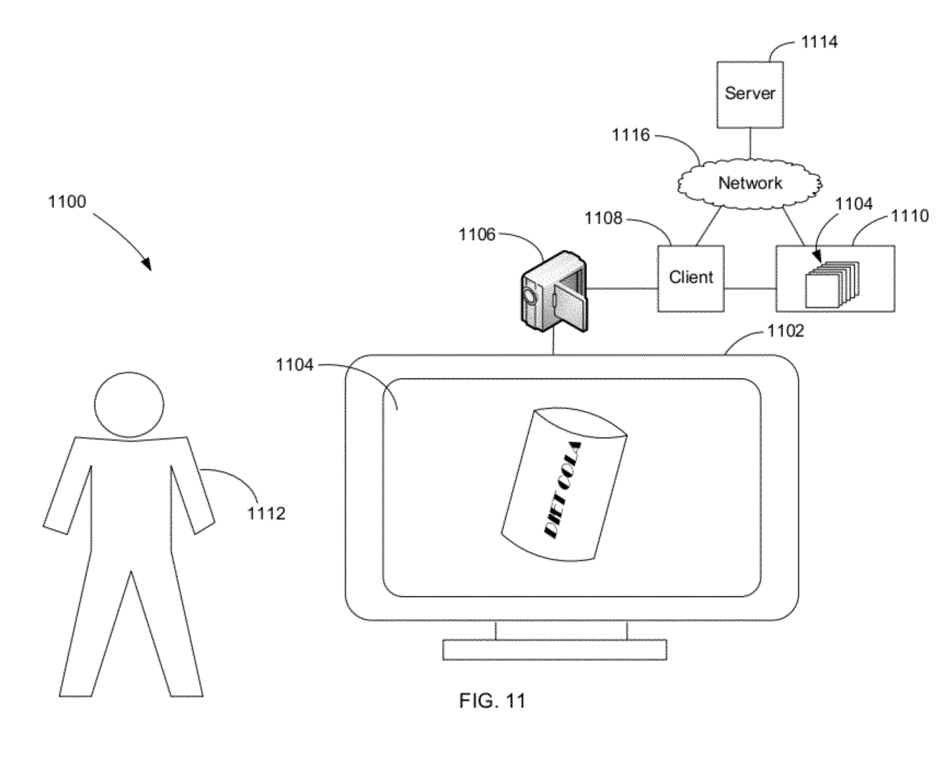

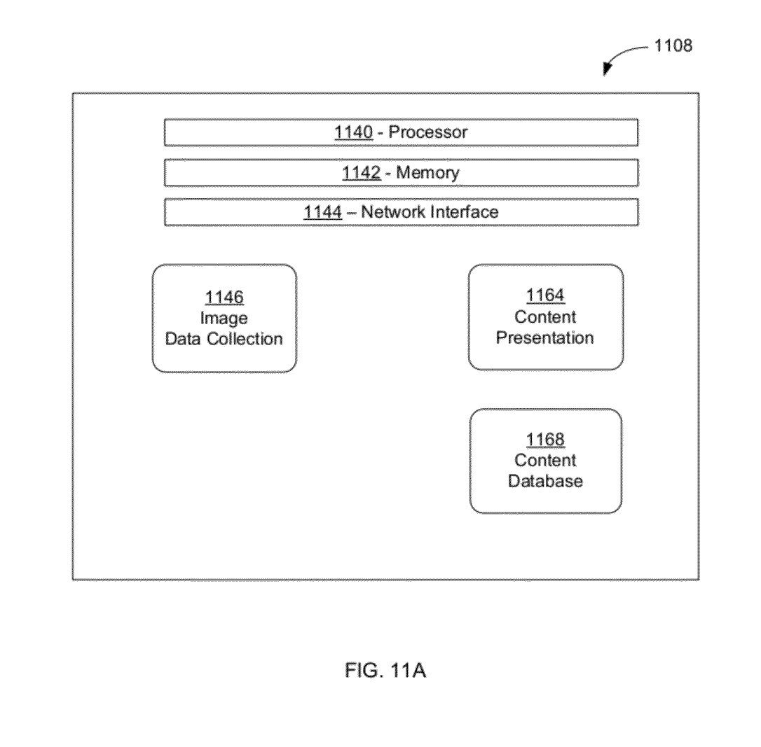

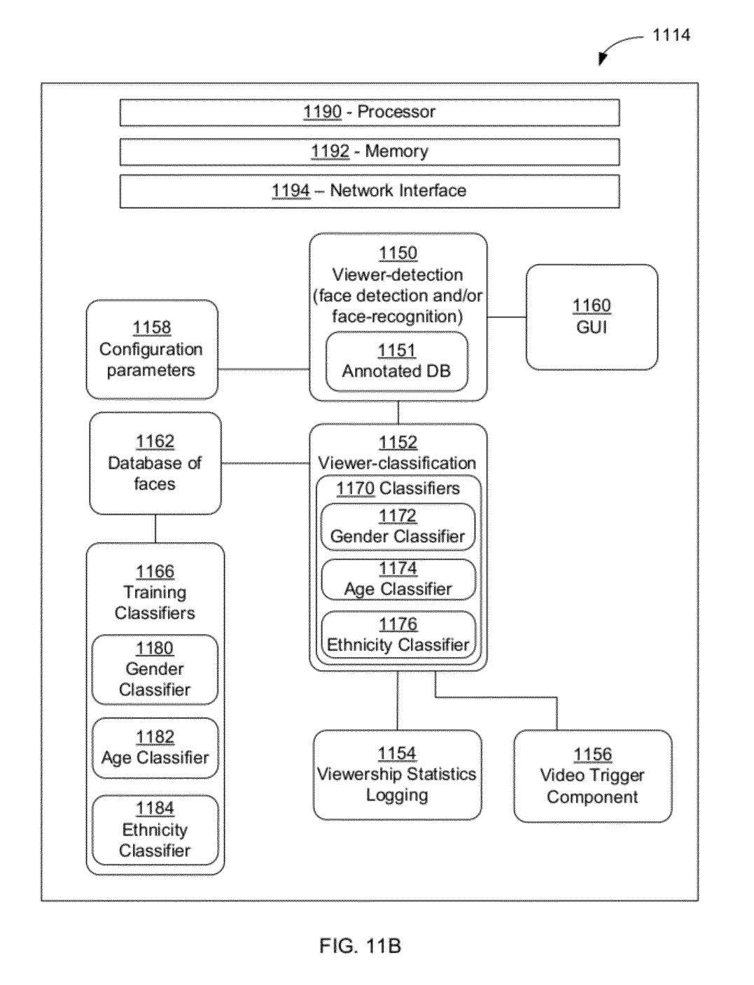

FIG. 11 is a viewer-driven content delivery system 1100 that displays a plurality of content items targeted to viewer groups, according to one embodiment. The viewer-driven content delivery system 1100 includes a content distribution space 1102, a plurality of content items 1104, a camera 1106, a client processing unit 1108, a media player 1110, and a server processing unit 1114. The viewer-driven content delivery system 1100 can detect a viewer, classify the viewer, and then display on the content distribution space 1102 one or more of the plurality of content items 1104 targeted to viewers having characteristics of the detected viewer 1112. The media player 1110 may deliver to the content distribution space 1102 the content item 1104 that is targeted to the viewer(s) 1112 based on viewer characteristics gathered by the camera 1106 and the client processing unit 1108 and/or the server processing unit. In the illustrated embodiment, the displayed content item 1104 may be an advertisement, such as a soft drink advertisement.

The camera 1106 can be configured and positioned to capture images (still images and/or video) of a viewer 1112 approaching or otherwise within viewing distance of the content distribution space 1102. The image data is communicated to the client processing unit 1108 and/or the server processing unit 1114 and used to ascertain characteristics about the viewer 1112. The client processing unit 1108 and/or the server processing unit 1114 may also detect whether the viewer 1112 actually views the content item 1104 being displayed and may gather statistics about viewers of the content item 1104.

The content distribution space 1102 can be a video monitor as shown in FIG. 11. The content distribution space 1102, for example, may be in a store window or part of a display of a product line. In another embodiment, the content distribution space 1102 may be a digital sign for presenting various pieces of mass media content. In other embodiments, the content distribution space 1102 can be electronic and/or digital signage, a rotating or scrolling sign, or any other content display capable of displaying one or more content items at indoor, in-store, and/or outdoor locations The content distribution space 1102 may be capable of displaying a single content item 1104 at any given time. In another embodiment, the content distribution space 1102 may be capable of displaying a plurality of content items 1104 simultaneously. The content distribution space 1102 may further include speakers (not shown) to provide audio content. In another embodiment, the content distribution space 1102 may further include audio outputs to connect to external speakers. The content items may include, but are not limited to images, video, audio, presentation slides, picture-in-picture, scrolling ticker, banners, and any other form of audio-visual content.

The media player 1110 may be capable of receiving inputs from the client processing unit 1108 and decide accordingly which media content item should play from a pool of one or more content items 1104. Accordingly, the data gathered by the viewer detection component 1150 and viewer classification component 1152 may be used by the media player 1110 to identify one or more of the plurality of content items 1104 that is targeted toward an audience, or at least one or more particular detected viewers 1112 of an audience.

To select corresponding media content from the pool of one or more content items 1104, each content item 1104 may have information associated with it, to characterize or otherwise classify the content item 1104. For example, the information could indicate that the content item 1104 is for Male-Child, Male-Youth, Male-Adult, Male-Senior, etc. Also there may be other information indicating how the system should behave for more than one viewer of the same gender or of different genders viewing the content distribution space 1102 at the same time. The pool of one or more content items 1104 may be stored in a database of content. The identified one or more content items 1104 that are targeted to the detected viewer 1112 can then be presented on the content distribution space 1102. In this manner the content item 1104 presented on the content distribution space 1102 is driven by a viewer 1112 of the content item 1104.

In another embodiment, the media player 1110 may simply receive an appropriate content item 1104 from the client processing unit 1108. The plurality of content items 1104 may be stored on, or otherwise accessible to the client processing unit 1108. The client processing unit 1108 may supply an appropriate targeted content item 1104 to the media player 1110 for delivery to the content distribution space 1102 to present to the viewer 1112. In still another embodiment, the server processing unit 1114 sends an instruction to the media player 1110 indicating which of the plurality of content items 1104 to present.

The client processing unit 1108 of the illustrated embodiment can include a processor, a memory, input and output devices and computer executable instructions for processing image data received from the camera 1106 and communicating the image data to the server processing unit 1114. The server processing unit 1114 may process the image data to both detect a viewer 1112 and classify the viewer 1112. The server processing unit 1114 can be coupled to the client processing unit 1108 via a computer network 1116, such as the Internet. Computer vision algorithms may be used to process the image data.

Specifically, as shown in FIG. 11A, the client processing unit 1108 may include a processor 1140, a memory 1142, a network interface component 1144, and various other components that may be implemented in hardware, software, or a combination thereof, including an image data collection module 1146, a content presentation component 1164, and a content database 1168.

The image data collection component 1146 may interface with the camera 1106 to collect image data of viewers approaching the content distribution space 1102 or otherwise within viewing distance of the content distribution space 1102. The collected image data may be communicated to the server processing unit 1114 via the network interface component 1144.

The content presentation component 1164 may receive input from the server processing unit 1114, for example a video trigger component 1156 of the server processing unit, regarding particular content item(s) to display to a detected viewer and/or audience. If the content presentation component 1164 does not receive any input, then it may continue to display its own scheduled content item 1104. If the content presentation component 1164 receives input from the video trigger component 1156, then it may be configured to display the indicated particular content items. The content item presented can be based on viewer information gathered by the viewer-driven content delivery system 1100. In another embodiment, the content presentation component 1164 may provide to the media player a content item that is targeted to the detected viewer. The client processing unit 1108 may further include a content database 1168 to store a plurality of content items 1104 and their associated characteristics.

In still another embodiment, the plurality of content items 1104 may be stored on the server processing unit 1114. The client processing unit 1108 may communicate viewer characteristics to the server processing unit 1114 and/or retrieve one or more of the plurality of content items 1104 that are targeted to the viewer 1112 from the remote server.

As can be appreciated, the media player 1110 and the client processing unit 1108 are not necessarily separate devices. The various components can be combined in any suitable manner.

In the illustrated embodiment, much of the image data processing may occur on the server processing unit 1114. As shown in FIG. 11B, the server processing unit 1114 may include a processor 1190, a memory 1192, a network interface component 1194, and various other components that may be implemented in hardware, software, or a combination thereof, including a viewer detection component 1150, a viewer classification component 1152, a viewership statistics logging component 1154, video trigger component 1156, a configuration parameters component 1158, a graphical user interface (GUI) component 1160, a database of faces 1162, and a training classifiers component 1166.

The viewer detection component 1150 may detect a viewer by performing face detection and/or recognition, similar to the viewer detection component 1050 described above with reference to FIG. 10A. Similarly, the viewer classification component 1152 may classify a detected face according to one or more classifications, similar to the viewer classification component 1052 described above with reference to FIG. 10A. The viewer classification module 1152 may include various classifiers 1170, for example a gender classifier 1172, an age classifier 1174, and an ethnicity classifier 1176, to perform aspects of the viewer classification. The database of faces 1162 may be compiled using training classifiers 1166, which may classify sample faces against which a detected face can be compared. The training classifiers may similarly include a gender classifier 1180, an age classifier 1182, and an ethnicity classifier 1184. The training classifiers may be internal to the server processing unit 1114 as reflected in FIG. 11B. In another embodiment, the training classifiers may be external to the viewer-driven content delivery system 1100, allowing building of the database of faces 1162 offline using processing power external to the processor 1140 and other external resources. The database of faces 1162, or updates to the database of faces, can then be uploaded to the server processing unit 1114.

The data (including viewership statistics) gathered by the viewer detection component 1150 and the viewer classification component 1152 can be stored by the viewership statistics logging component 1154 in an audience statistics log and used to determine viewership statistics of the particular content distribution space 1102 and/or the content item 1104. For example, the stored data may include date, time, number of views, view duration, duration split (e.g., 1-3 seconds, 4-7 seconds, 8-10 seconds, above 10 seconds), gender split (male and female), age split (e.g., child, youth, adult & senior). This data can be stored in a database to provide data mining operations for the user to generate various reports. Based on the stored data, reports can be generated corresponding to a given input, such as date, hours, etc., in graphical format and tabular format. Reports can also be generated based on the actual play log. The data can also be analyzed to better determine effectiveness and price of content distribution space 1102 as well as the effectiveness of a content item 1104 and the types of content that are of interest to groups of viewers. As described previously, the server processing unit 1114 may gather and store data, including viewership statistics, from a plurality of client processing units 1108. The collection of viewership statistics from a plurality of client processing units 1108 may enhance the usefulness of the data for such purposes as statistical analysis, data mining, and report generation.

The video trigger component 1156 may be configured to communicate targeted content information to the client processing unit 1108. For example, the video trigger component 1156 may provide input to a content presentation component 1164 of the client processing unit 1108. The video trigger component may analyze the available plurality of content items 1104 in the content database 1168, with their associated parameters, and choose the content item(s) 1104 to be displayed based on the detected viewer and/or audience profile. The video trigger component 1156 may provide an indication to the content presentation component 1164 as to the content item 1104 that should be presented.

In another embodiment, the video trigger component 1156 may simply communicate viewer detection and viewer classification data to the content presentation component 1164, and the content presentation component 1164 may analyze the available plurality of content items 1104 in the content database 1168, with their associated parameters, and choose the content item(s) 1104 to be displayed based on the viewer detection and viewer classification data. In still another embodiment, the video trigger component 1156 may be configured to trigger, for example, a content presentation component 1164 to present a content item 1104 based on a detected current viewer profile, for example, Male-Adult. The content item 1104 and its associated configuration can be changed remotely, for example, at a server.

The configuration parameters component 1158 may read from a configuration file, which contains parameters for program use. The configuration parameters component 1158 may also provide an option to read the current configuration and to change any configuration parameters.

The graphical user interface (GUI) component 1160 may present a GUI that allows a user to configure various parameters and to initiate and/or terminate viewer detection and/or viewer classification. The GUI may also present viewer classification information. In particular, the GUI may present results of various viewer classification processes run on a detected face, such as gender classification, age classification, and ethnicity classification. The GUI 1160 may also present the statistics of detected faces. The GUI may present these statistics by numbers and graphs.

As can be appreciated, the server processing unit 1114 may not be a single device. The server processing unit 1114 may comprise multiple devices, and image processing may be accomplished in a distributed manner, for example, by cloud computing. As can also be appreciated, the components described herein as residing on the client processing unit 1108 may reside on the server processing unit 1114. Similarly, the components described herein as residing on the server processing unit 1114 may reside on the client processing unit 1108. For example, the viewer detection component 1150 may reside on the client processing unit 1108 and the viewer classification component 1152 may reside on the server processing unit 1114.

The present disclosure has been made with reference to various exemplary embodiments including the best mode. However, those skilled in the art will recognize that changes and modifications may be made to the exemplary embodiments without departing from the scope of the present disclosure. For example, various operational steps, as well as components for carrying out operational steps, may be implemented in alternate ways depending upon the particular application or in consideration of any number of cost functions associated with the operation of the system, e.g., one or more of the steps may be deleted, modified, or combined with other steps.

Additionally, as will be appreciated by one of ordinary skill in the art, principles of the present disclosure may be reflected in a computer program product on a tangible computer-readable storage medium having computer-readable program code means embodied in the storage medium. Any suitable computer-readable storage medium may be utilized, including magnetic storage devices (hard disks, floppy disks, and the like), optical storage devices (CD-ROMs, DVDs, Blu-Ray discs, and the like), flash memory, and/or the like. These computer program instructions may be loaded onto a general purpose computer, special purpose computer, or other programmable data processing apparatus to produce a machine, such that the instructions that execute on the computer or other programmable data processing apparatus create means for implementing the functions specified. These computer program instructions may also be stored in a computer-readable memory that can direct a computer or other programmable data processing apparatus to function in a particular manner, such that the instructions stored in the computer-readable memory produce an article of manufacture including instruction means which implement the function specified. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified.

While the principles of this disclosure have been shown in various embodiments, many modifications of structure, arrangements, proportions, the elements, materials and components, used in practice, which are particularly adapted for a specific environment and operating requirements may be used without departing from the principles and scope of this disclosure. These and other changes or modifications are intended to be included within the scope of the present disclosure.

The foregoing specification has been described with reference to various embodiments. However, one of ordinary skill in the art appreciates that various modifications and changes can be made without departing from the scope of the present disclosure. Accordingly, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Also, as used herein, the terms “coupled,” “coupling,” or any other variation thereof, are intended to cover a physical connection, an electrical connection, a magnetic connection, an optical connection, a communicative connection, a functional connection, and/or any other connection.

It will be obvious to those having skill in the art that many changes may be made to the details of the above-described embodiments without departing from the underlying principles of the invention. The scope of the present invention should, therefore, be determined by the following claims.

What is claimed is:

1. A system for gathering viewership statistics on viewers of content, comprising:
a camera configured to capture images within a field of view of the camera of an area where potential viewers of an associated content distribution space pass, wherein the content distribution space displays a content item; and
a processing unit configured to process images captured by the camera, wherein the processing unit comprises:
a viewer detection module to detect an actual viewer of the content item by processing an image captured by the camera and performing face detection to distinguish a face of a potential viewer from other aspects of the captured image and comparing the detected face of the potential viewer in the captured image to sample images having various known facial features to make a determination if the potential viewer is an actual viewer of the content item, and
a viewer classification module to identify characteristics of the actual viewer by comparing the detected face of the actual viewer to sample images having known facial features and classifying the actual viewer according to identified characteristics of the detected face; and
a viewer statistics logging module to store audience statistics in an audience statistics log, the audience statistics including data from the viewer detection module and data from the viewer classification module.

2. The system of claim 1, wherein the audience statistics stored in the audience statistics log include one of a number of views of the content item, a duration of each view, and a number of opportunities to see (OTSs) the content item.

3. The system of claim 1, wherein the viewer detection module further performs one of motion detection and object tracking.

4. The system of claim 1, wherein the viewer detection module performs face detection using the Viola Jones Algorithm.

5. The system of claim 1, wherein the viewer classification module performs one of age classification, gender classification, and ethnicity classification.

6. The system of claim 1, wherein the viewer classification module concurrently performs age classification, gender classification, and ethnicity classification.

7. The system of claim 1, wherein viewer classification includes processing the detected image with one of a AdaBoost algorithm and a Support Vector Machine (SVM) algorithm.

8. The system of claim 1, further comprising a content delivery system configured to present a plurality of content items on the content distribution space, wherein the viewer statistics logging module is further configured to track a time during which each of the plurality of content item is presented and configured to track audience statistics for each of the plurality of content items.

9. The system of claim 8, wherein the plurality of content items are stored at a remote server, wherein the processing unit is configured to receive one or more of the plurality of content items from the remote server.

10. A system for delivering viewer-driven content, comprising:
a camera configured to capture images within a field of view of the camera of an area where potential viewers of an associated content distribution space pass, wherein the content distribution space displays a content item; and
a processing unit configured to process images captured by the camera, wherein the processing unit comprises:
a viewer detection module to detect an audience of one or more potential viewers of the associated content distribution space by processing an image captured by the camera and performing viewer detection algorithms to distinguish a face of a potential viewer from other aspects of the captured image, and
a viewer classification module to identify characteristics of the one or more potential viewers by comparing each detected face of the one or more potential viewers to sample images having known facial features to identify facial features of the detected face and classifying each potential viewer according to the identified facial features of respective detected face, and
a content delivery system configured to receive input regarding the characteristics of the audience of one or more potential viewers and present content to the audience based on those characteristics on the associated content distribution space.

11. The system of claim 10, wherein the viewer detection module is further configured to compare the detected face of the potential viewer in the captured image to sample images having various known facial features to make a determination if the potential viewer is an actual viewer of the content item.

12. The system of claim 11, further comprising a viewer statistics logging module to store audience statistics in an audience statistics log based on time, the audience statistics including data from the viewer detection module and data from the viewer classification module.

13. The system of claim 10, wherein the content delivery system further comprises a media player in communication with the content distribution space and the processing unit, the media player configured provided the selected content item to the content distribution space.

14. The system of claim 10, wherein the processing unit content delivery system further comprises a video trigger module configured to analyze parameters associated with each of a plurality of content items available for presentation and select the content item to be displayed based on identified characteristics of the audience of one or more potential viewers.

15. The system of claim 10, further comprising a content distribution space configured to present the selected content item for viewing by the audience.
